(19) United States
(12) Patent Application Publication
(10) Pub. No.: US 2026/0309611 A1
(43) Pub. Date: Oct. 8, 2026

(54) SYSTEM FOR DETERMINING FILTER STATUS

(71) Applicant: DDP SPECIALTY ELECTRONIC MATERIALS US, LLC, Wilmington, DE (US)

(72) Inventors: Guillem GILABERT ORIOL, Tarragona (ES); Gerard MASSONS, Tarragona (ES); Leaelaf Mengistu HAILEMARIAM, Edina, MN (US); Wenyu SU, Midland, MI (US)

(21) Appl. No.: 19/482,171

(22) PCT Filed: May 9, 2024
(86) PCT No.: PCT/US2024/028632

§ 371 Date: Nov. 6, 2025

(30) Foreign Application Priority Data
May 12, 2023 (ES) 202330840

(51) Int. Cl. G01N 15/08; B01D 61/02; B01D 65/10; C02F 1/00; C02F 1/44; G06F 17/11

(52) U.S. Cl. CPC G01N 15/0826; B01D 65/109; C02F 1/008; G06F 17/11; B01D 61/025; B01D 61/027; B01D 2313/701; C02F 1/441; C02F 1/442; C02F 2209/006; C02F 2209/03; C02F 2209/40; C02F 2303/16; C02F 2303/20; G01N 2015/084

(57) ABSTRACT

An example system for determining a filter status is provided. The system includes a database configured to electronically store data, the data including past performance data of one or more water filtration elements. The system includes a processing device in communication with the database. The processing device is configured to receive as input the past performance data, and identify one or more data points within the past performance data indicative of a cleaning event for the water filtration elements. The processing device is configured to divide the past performance data into individual data segments, each of the individual data segments representing data of the past performance data in-between respective identified cleaning events, fit a mathematical function to each of the individual data segments, and identify a type of fouling occurring during each of the individual data segments based on the mathematical function fitted to the respective individual data segment.

### CROSS-REFERENCE TO RELATED APPLICATION

The present application claims priority to Spanish Utility Model Appln. No. 202330840, filed on May 21, 2023, which is incorporated herein by reference in its entirety.

### TECHNICAL FIELD

The present invention relates to a method and system for automated monitoring of filter membranes in a water treatment facility, and for detection and identification of membrane fouling types in a water treatment facility. The method and system are usable for efficiently determining when cleaning of filter membranes is needed, and provide accurate guidance of the filter membranes based on the identified type of fouling.

### BACKGROUND

Water treatment systems are available in a variety of configurations, including systems that perform pressure-driven membrane separation processes for water filtration. Such pressure-driven membrane separation processes allow a broad range of neutral and ionic species to be removed from fluids. In order of decreasing pore size, membranes are commonly classified into several categories: microfiltration (MF), ultrafiltration (UF), nanofiltration (NF), and reverse osmosis (RO). Microfiltration is used for removal of suspended particles having particle sizes greater than 0.1 microns. Ultrafiltration commonly excludes dissolved molecules having molecular weights greater than 5,000 daltons. Nanofiltration membranes pass at least some salts but usually have high retention of organic compounds having molecular weights greater than approximately 200 daltons. Reverse osmosis membranes have high retention of almost all species.

NF and RO membranes are most commonly used in applications such as desalination of seawater or brackish water, production of ultrapure water, color removal, waste water treatment, and concentration of liquids for food products. A critical factor in almost all NF and RO applications is that the membrane achieve high rejection of small solute molecules while maintaining high flux.

A spiral wound element is the most common configuration for RO and NF membranes. A traditional spiral wound element design is illustrated in FIG. 1. The element generally includes membrane envelopes 2 and a feed spacer sheet 4 wrapped about a central permeate collection tube 6. The envelopes 2 include two membrane sheets 8 surrounding a permeate carrier sheet 10, with the structure held together by adhesive 12 along edges 14, 16, 18. The fourth edge 20 of the envelope 2 abuts the permeate collection tube 6 such that the permeate carrier sheet 10 is in fluid contact with openings 22 in the permeate collection tube 6. Each envelope 2 is separated by feed spacer sheet 4 that is also wound about the collection tube 6. The feed spacer 4 is in fluid contact with both ends of the element 24, 26 and acts as a conduit for feed solution across the front surface 28 of membrane 8. The direction of feed flow 30 is from the entrance end 24 to the concentric end 26, and this direction is parallel to the axis 32 of the central permeate collection tube 6. As such, “feed” liquid flows axially through the feed spacer sheet 4 and exits on the opposite end as “concentrate”. “Permeate” passes under pressure through membrane envelopes 2 and is directed to a permeate collection tube 6 by a permeate carrier sheet 10.

Over time, the performance level of the filtration elements can decline due to the accumulation of foreign material on the feed spacer or the membrane (e.g., fouling) and/or salt deposition (e.g., scaling). Such drop in performance level can affect the quality of the filtered water and/or places greater pressure on the water filtration system during operation, which can result in increased maintenance efforts over time.

Manufacturers of the filtration elements and/or water treatment systems generally set certain guidelines for cleaning the filtration elements. Typically, this involves monitoring the overall operation of the water treatment system and stopping operation of the system to clean the filters when certain operational characteristics are detected (e.g., the pressure drop across an element surpasses a recommended threshold). For proper cleaning, it is generally recommended that the system is shut down, affected filtration elements are cleaned, and some of the affected elements are sent to a laboratory for a detailed analysis of the type of fouling and/or scaling. Typically, however, water treatment plant operators push the filtration system beyond the recommended guidelines to avoid a shutdown of the overall system for extended periods of time. This may result in further problems, e.g., pump overheating, low product quality, or the like, which would force a system shutdown.

At this point, rather than sending the filtration element to a laboratory, the operator may try to rely on experience to guess the type of fouling/scaling occurring and clean the system using chemicals they believe may be appropriate. In such instances, the type of chemicals used may not be appropriate and may not address the actual fouling/scaling occurring. This can result in a cleaned filtration element having a performance baseline lower than the performance level the filtration element would have if proper cleaning was performed. After repeated cleaning attempts, the filtration elements and/or the water treatment facility can encounter additional operational breakdowns, resulting in increased costs in operation and inadequately filtered water.

### SUMMARY

The exemplary system for determining filter status can be used by plant operators to improve their system performance. The system can analyze past performance to identify past cleaning-in-place (CIP) events and the type of filtration module failure modes based on the performance of the system in the inter and intra-CIP periods. The system can be used for nanofiltration and/or reverse osmosis systems to identify fouling, scaling, and/or membrane failure modes. In some embodiments, the system can be used to predict when the next cleaning should/will take place and to recommend the most suitable cleaning procedure.

Membrane fouling is a complicated issue in nanofiltration and reverse osmosis systems. As such, identifying the dominant fouling mechanism during the filtration process can be of great significance for the prediction of the next cleaning cycle and for control of fouling. The real-time (or substantially real-time) monitoring of the water treatment facility to detect and identify fouling types allows for early detection and reaction of the facility operators to prevent excessive fouling and potentially negative effects on the rest of the system. The system provides an accurate means for determining the type of fouling occurring, and thereby provides accurate recommendations for the cleaning cycle to ensure steps are taken to properly address the fouling event(s). In some embodiments, the system can be used to anticipate cyclical and/or seasonal fouling, such that fouling event(s) can be minimized and/or avoided.

In accordance with embodiments of the present disclosure, an exemplary method for analyzing the performance of a feedwater filtration system is provided. The method includes collecting performance data from said filtration system, normalizing said dataset to conditions at startup, removing physically inconsistent data points from said dataset, removing statistical outliers from said dataset, identifying membrane cleaning events in the said dataset, dividing said dataset into a plurality of data segments between said membrane cleaning events, fitting mathematical functions to said data segments, analyzing the coefficient of determination of said mathematical functions, calculating derivatives of said mathematical functions with respect to time, and determining a type of fouling based on said derivatives and said coefficient of determination.

The filtration system includes at least one filtration module. The filtration module includes one or more of a reverse osmosis element, a nanofiltration element, or a hyperfiltration element. The collection of performance data can be performed by sensors installed in said filtration system. Normalization of said dataset can be performed to account for variation of said feedwater temperature, said feedwater composition, or feed pressure. Removal of outliers in said dataset can be performed by a statistical means including the steps of calculating a percentage change of a data point (yₜ) from the previous datapoint (yₜ₋₁), calculating a percentage change of the next data point (yₜ₊₁) from said datapoint (yₜ), comparing the previous percentage changes with a drop limit value, and identifying the datapoint (yₜ) as an outlier if the percentage changes exceed said drop limit value.

Removal of physically inconsistent data points in said dataset can be performed by application of a set of criteria including one or more of the following: feed flow must be greater than concentrate flow, feed flow must be greater than permeate flow, feed pressure must be greater than concentrate pressure, feed pressure must be greater than permeate pressure, feed pressure must be greater than pressure drop across the filtration module, permeate conductivity must be less than feed conductivity, pressure drop across the filtration module must be less or equal to the difference between the feed pressure and concentrate pressure, and/or the osmotic pressure of the feed stream must be less than the feed pressure.

The dataset can include normalized pressure drop across a filtration module (dP), normalized permeate flow from the filtration module (Pf), and normalized salt passage through the filtration module (Sp). The membrane cleaning events can be identified using a differencing series method of dP and Pf, where said differencing series method can include the steps of calculating the difference between a datapoint (yₜ) and the previous datapoint (yₜ₋₁) to generate said differencing series for dP and Pf, calculating the average and standard deviations of said differencing series for dP and Pf, comparing each value in the differencing series for dP or Pf to the sum of the corresponding differencing series and the product of a Differencing Constant and the corresponding standard deviation of the differencing series, checking if there is a gap in the dataset, and checking if the gap is wider than a CIP Reference Time. The Differencing Constant is a positive whole number, preferably a number from 1 to 10, inclusive; more preferably a number from 3 to 7, inclusive; and still more preferably 5. The CIP Reference time is a time interval defined by the user as indicative of a typical duration of a CIP for the system of interest and can range from minutes to days. An exemplary value for the CIP Reference time can be, e.g., 120 minutes, 1 day, or the like. Preferred CIP Reference times are from 5 minutes to two weeks, and 1 day is a more preferred CIP Reference time.

In determining the type of fouling occurring in the filtration element(s), the system analyzes data from the filtration element(s) to determine whether a variety of parameters are met. As discussed herein, some parameters are considered “primary” parameters and some parameters are considered “secondary” (e.g., optional) parameters depending on the fouling type involved. For each fouling type, there may be one or more primary parameters and one or more secondary parameters. In some instances, the data can meet the criteria for, e.g., only one primary parameter, more than one primary parameter, only one or more secondary parameters, or the like. The system can therefore initially review the data to determine whether one or more of the primary parameters are met. If so, the system can estimate the fouling type based on the primary parameter(s) met. In some embodiments, the system can estimate the fouling type based on only one primary parameter that has been met. In some embodiments, the system can rely on additional primary parameters and/or secondary parameters that have been met to solidify, reinforce or support the original estimate of the fouling type occurring based on the original primary parameter that has been met. The system can therefore initially determine if a primary parameter has been met to estimate the fouling type. If no primary parameters have been met, the system can review the secondary parameters to estimate the fouling type based on the secondary parameter(s) that have been met. In some embodiments, if overlap exists between the possible fouling types based on the primary and/or secondary parameter(s) met, the system can perform a ranking operation to determine the likelihood of the type of fouling type occurring, e.g., based on historical data, or the like. Although some parameters are discussed as being based on 1^{st} or 2^{nd} order polynomial functions, in some embodiments, the parameters can be identified based on, e.g., exponential functions, higher order polynomial functions, linear functions, non-linear functions, or the like.

Fitting of a set of curves to said data segments can be performed using a statistical means. In some embodiments, the mode of filtration module failure in a data segment can be identified as scaling if at least one of the following conditions is met: (a) the coefficient of determination of dP to a 1^{st} order polynomial is greater than 0.7, (b) the coefficient of determination of dP to a 2^{nd} order polynomial is greater than 0.7, (c) the difference between the coefficient of determination values for 2^{nd} order and 1^{st} order polynomials fitted to dP is less than 0.3, (d) the coefficient of determination of Sp to a 1st order polynomial is greater than 0.7, (e) the coefficient of determination of Sp to a 2^{nd} order polynomial is greater than 0.7, (f) the difference between the coefficient of determination values for 2^{nd} order and 1^{st} order polynomials fitted to Sp is less than 0.3, (g) the coefficient of determination of Pf to a 1st order polynomial is greater than 0.7, (h) the coefficient of determination of Pf to a 2^{nd} order polynomial is greater than 0.7, (i) the difference between the coefficient of determination values for 2^{nd} order and 1^{st} order polynomials fitted to Pf is less than 0.3, (j) dP increases with time in said data segment, (k) Pf decreases with time in said data segment, and/or (l) Sp increases with time in said data segment.

In some embodiments, the mode of filtration module failure in a data segment can be identified as particulate fouling if at least one of the following conditions is met: (a) the coefficient of determination of dP to a 1^{st} order polynomial is greater than 0.7, (b) the coefficient of determination of dP to a 2^{nd} order polynomial is greater than 0.7, (c) the difference between the coefficient of determination values for 2^{nd} order and 1^{st} order polynomials fitted to dP is less than 0.3, (d) the coefficient of determination of Pf to a 1^{st} order polynomial is greater than 0.7, (e) the coefficient of determination of Pf to a 2^{nd} order polynomial is greater than 0.7, (f) the difference between the coefficient of determination values for 2^{nd} order and 1^{st} order polynomials fitted to Pf is less than 0.3, (g) the coefficient of determination of Sp to a 1^{st} order polynomial is greater than 0.7, (h) the coefficient of determination of Sp to a 2^{nd} order polynomial is greater than 0.7, (i) the difference between the coefficient of determination values for 2^{nd} order and 1^{st} order polynomials fitted to Sp is less than 0.3, (j) dP increases overtime in said data segment, (k) Pf decreases over time in said data segment, and/or (l) Sp increases with time in said data segment.

In some embodiments, the mode of filtration module failure in a data segment can be identified as biofouling if at least one of the following conditions is met: (a) the coefficient of determination of dP to a 1^{st} order polynomial is greater than 0.4, (b) the coefficient of determination of dP to a 2^{nd} order polynomial is greater than 0.7, (c) the difference between the coefficient of determination values for 2^{nd} order and 1^{st} order polynomials is greater than 0.3, (d) the coefficient of determination of Pf to a 1^{st} order polynomial is greater than 0.4, (e) the coefficient of determination of Pf to a 2^{nd} order polynomial is greater than 0.7, (f) the difference between the coefficient of determination values for 2^{nd} order and 1^{st} order polynomials fitted to Pf is greater than 0.3, (g) the coefficient of determination of Sp to a 1^{st} order polynomial is greater than 0.4, (h) the coefficient of determination of Sp to a 2^{nd} order polynomial is greater than 0.7, (i) the difference between the coefficient of determination values for 2^{nd} order and 1^{st} order polynomials fitted to Sp is greater than 0.3, (j) dP increases over time in said data segment, (k) Pf decreases over time in said data segment, and/or (l) Sp increases over time in said data segment.

In some embodiments, the mode of filtration module failure in a data segment can be identified as membrane integrity failure (e.g., due to oxidation or membrane damage, or the like) if at least one of the following conditions is met: (a) the coefficient of determination of Pf to a 1^{st} order polynomial is greater than 0.7, (b) the coefficient of determination of Pf to a 2^{nd} order polynomial is greater than 0.7, (c) the difference between the coefficient of determination values for the 2^{nd} order and 1^{st} order polynomials fitted to Pf is less than 0.3, (d) the coefficient of determination of Sp to a 1^{st} order polynomial is greater than 0.7, (e) the coefficient of determination of Sp to a 2^{nd} order polynomial is greater than 0.7, (f) the difference between the coefficient of determination values for 2^{nd} order and 1^{st} order polynomials fitted to fitted to Sp is less than 0.3, (g) the coefficient of determination of dP to a 1st order polynomial is greater than 0.7, (h) the coefficient of determination of dP to a 2^{nd} order polynomial is greater than 0.7, (i) the difference between the coefficient of determination values for 2^{nd} order and 1^{st} order polynomials fitted to dP is less than 0.3, (j) dP remains constant with time in said data segment, (k) Pf increases over time in said data segment, and/or (l) Sp increases over time in said data segment.

In some embodiments, the mode of filtration module failure in a data segment can be identified as organic fouling if at least one of the following conditions is met: (a) the coefficient of determination of Pf to a 1st order polynomial is greater than 0.4, (b) the coefficient of determination of Pf to a 2^{nd} order polynomial is greater than 0.7, (c) the difference between the coefficient of determination values for the 2^{nd} order and 1^{st} order polynomials fitted to Pf is greater than 0.3, (d) the coefficient of determination of Sp to a 1^{st} order polynomial is greater than 0.4, (e) the coefficient of determination of Sp to a 2^{nd} order polynomial is greater than 0.7, (f) the difference between the coefficient of determination values for 2^{nd} order and 1st order polynomials fitted to fitted to Sp is greater than 0.3, (g) the coefficient of determination of dP to a 1^{st} order polynomial is greater than 0.7, (h) the coefficient of determination of dP to a 2^{nd} order polynomial is greater than 0.7, (i) the difference between the coefficient of determination values for 2^{nd} order and 1^{st} order polynomials fitted to dP is less than 0.3, (j) dP remains constant with time in said data segment, (k) Pf decreases over time in said data segment, and/or (l) Sp decreases over time.

In some embodiments, said drop limit can be greater than 0 and less than 10%. In some embodiments, said Differencing Constant can be greater than 0 and less than 10. In some embodiments, said CIP Reference Time can be greater than 0 and less than 10 days. The exemplary method can include the steps of comparing performance parameters before and after cleaning to ensure proper CIP and/or fouling identification. As such, the exemplary system and method can be used to identify filtration module failure modes and provide guidance for optimal cleaning to ensure efficient operation of the water filtration system.

In accordance with embodiments of the present disclosure, an exemplary system for determining a filter status is provided. The system includes a database configured to electronically store data, the data including past performance data of one or more water filtration elements. The system includes a processing device in communication with the database. The processing device is configured to receive as input the past performance data, and identify one or more data points within the past performance data indicative of a cleaning event for the water filtration elements. The processing device is configured to divide the past performance data into individual data segments, each of the individual data segments representing data of the past performance data in-between respective identified cleaning events. The processing device is configured to fit a mathematical function to each of the individual data segments. The processing device is configured to identify a type of fouling occurring during each of the individual data segments based on the mathematical function fitted to the respective individual data segment.

In some embodiments, the processing device can be configured to normalize the past performance data to conditions at startup of the one or more water filtration elements before identifying the cleaning events. In some embodiments, the processing device can account for a variation of at least one of a feedwater temperature, a feedwater composition, or a feed pressure, when normalizing the past performance data.

In some embodiments, the processing device can be configured to identify and remove physically inconsistent data points from the past performance data before identifying the cleaning events. In some embodiments, the physically inconsistent data point is removed from the past performance data if at least one of the following conditions is not true: feed flow is greater than concentrate flow, the feed flow is greater than permeate flow, feed pressure is greater than concentrate pressure, and/or the feed pressure is greater than permeate pressure. In some embodiments, the physically inconsistent data point is removed from the past performance data if at least one of the following conditions is not true: feed flow is greater than concentrate flow, the feed flow is greater than permeate flow, feed pressure is greater than concentrate pressure, the feed pressure is greater than permeate pressure, the feed pressure is greater than pressure drop across the one or more water filtration elements, permeate conductivity is less than feed conductivity, the pressure drop across the one or more water filtration elements is less than or equal to a difference between the feed pressure and the concentrate pressure, and/or osmotic pressure of a feed stream is less than the feed pressure.

In some embodiments, the processing device can be configured to identify and remove statistical outlier data points from the past performance data before identifying the cleaning events. In such embodiments, identifying and removing the statistical outlier data points from the past performance data includes calculating a percentage change of a data point (yₜ) from a previous data point (yₜ₋₁), calculating a percentage change of a next data point (yₜ₊₁) from the data point (yₜ), comparing a previous percentage changes with a drop limit value, and identifying the data point (yₜ) as an outlier if the percentage changes exceed the drop limit.

In some embodiments, identifying the cleaning events can include applying a differencing series method to normalized pressure drop (dP) and normalized permeate flow (Pf) from the past performance data. Applying the differencing series method can include the steps of (i) calculating a difference between the data point (yₜ) and the previous data point (yₜ₋₁) to generate a differencing series for the normalized pressure drop (dP) and the normalized permeate flow (Pf), (ii) calculating an average and standard deviations for the differencing series for the normalized pressure drop (dP) and the normalized permeate flow (Pf), (iii) comparing each value in the differencing series for the normalized pressure drop (dP) and the normalized permeate flow (Pf) to a sum of corresponding differencing series and a product of a differencing constant and a corresponding standard deviation of the differencing series, (iv) determining if a gap exists in the dataset, and (v) determining if the gap is wider than a CIP reference time.

In some embodiments, the processing device can be configured to analyze a coefficient of determination of the mathematical function and calculate derivatives of the mathematical function with respect to time. In such embodiments, the processing device can be configured to identify the type of fouling based on the derivatives of the coefficient of determination. In some embodiments, the one or more water filtration elements can be at least one of a reverse osmosis element, a nanofiltration element, or a hyperfiltration element. The system can include one or more sensors configured to detect and transmit data for pressure drop, salt passage, and permeate flow associated with each of the one or more water filtration elements for storage in the database as the past performance data.

In some embodiments, the past performance data can include pressure drop, salt passage, and permeate flow for each of the one or more water filtration elements. If no change in the pressure drop, salt passage, and permeate flow is detected, the processing device can identify a no fouling condition. If an increase in the pressure drop fits a 2nd order polynomial function, the processing device can identify the type of fouling as biofouling. In some instances of biofouling, the salt passage may increase and the permeate flow may decrease. If a decrease of the salt passage fits a 2nd order polynomial function, the processing device can identify the type of fouling as organic fouling. In some instances of organic fouling, the pressure drop may not change and the salt passage may decrease. If a steep increase in the pressure drop of first position elements (e.g., lead end filtration elements per FIG. 19) fits a 1st order polynomial function, the processing device can identify the type of fouling as particulate fouling. In some instances of particulate fouling, the salt passage may increase and the permeate flow may decrease. In some instances, such effects can be found primarily in the lead elements. If a gradual increase in the pressure drop of tail position elements (e.g., tail end filtration elements per FIG. 19) fits a 1st order polynomial function, the processing device can identify the type of fouling as scaling. In some instances of scaling, the salt passage may increase and the permeate flow may decrease. In some instances, such effects can be found primarily in the tail elements. If an increase in the permeate flow fits a 1st order polynomial function and an increase in the salt passage fits a 1st order polynomial function, the processing device can identify the type of fouling as an integrity membrane damage event. In some instances of an oxidation or membrane damage event, the pressure drop may not change.

In some embodiments, the processing device can be configured to receive as input current performance data of the one or more water filtration elements as received from one or more sensors (e.g., multiple sensors can be installed in the same filtration element(s) and/or the sensors can be installed in multiple filtration elements within the installation to provide a more comprehensive fouling diagnostic), analyze the current performance data based on the previous analysis of the past performance data and the identification of the type of fouling occurring during each of the individual data segments, estimate a current type of fouling occurring at the water filtration elements, and/or output a recommendation for a cleaning procedure specific to the current type of fouling occurring at the water filtration elements. The collected data from the sensors can be filtration element specific to identify if certain conditions are occurring at the lead end or the tail end of the pressure vessel to assist in estimating the fouling type occurring. In some embodiments, the current performance data and/or the past performance data can be used to predict potential fouling occurring in the future (e.g., based on a repeating cycle of fouling during specific times of year and/or based on environmental conditions).

In accordance with embodiments of the present disclosure, an exemplary method for determining a filter status is provided. The method includes receiving as input to a system for determining a filter status past performance data of one or more water filtration elements. The system for determining the filter status includes a database configured to electronically store the past performance data, and a processing device in communication with the database. The method includes identifying one or more data points within the past performance data indicative of a cleaning event for the one or more water filtration elements. The method includes dividing the past performance data into individual data segments, each of the individual data segments representing data of the past performance data in-between respective identified cleaning events. The method includes fitting a mathematical function to each of the individual data segments. The method includes identifying a type of fouling occurring during each of the individual data segments based on the mathematical function fitted to the respective individual data segment.

In accordance with embodiments of the present disclosure, an exemplary non-transitory computer-readable medium storing instructions for determining a filter status that are executable by a processing device is provided. Execution of the instructions by the processing device causes the processing device to receive as input to a system for determining a filter status past performance data of one or more water filtration elements. The system for determining the filter status includes a database configured to electronically store the past performance data, and the processing device in communication with the database. Execution of the instructions by the processing device causes the processing device to identify one or more data points within the past performance data indicative of a cleaning event for the one or more water filtration elements. This can be used to divide the past performance data into individual data segments, each of the individual data segments representing data of the past performance data in-between respective identified cleaning events. Execution of the instructions by the processing device causes the processing device to fit a mathematical function to each of the individual data segments. Execution of the instructions by the processing device causes the processing device to identify a type of fouling occurring during each of the individual data segments based on the mathematical function fitted to the respective individual data segment.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the system for determining filter status, reference is made to the accompanying figures, wherein:

FIG. 1 is a diagrammatic view of a traditional spiral wound filtration element;

FIG. 2 is a diagrammatic view of a portion of a feed spacer sheet of a filtration element showing strand thinning and several geometric relationships;

FIG. 3 is a diagrammatic view of a separation occurring in a spiral wound reverse osmosis or nanofiltration element;

FIG. 4 is a block diagram of an exemplary system for determining filter status in accordance with the present disclosure;

FIG. 5 is a block diagram of an exemplary computing device for implementing the exemplary system for determining filter status in accordance with the present disclosure;

FIG. 6 is a block diagram of an exemplary system for determining filter status environment in accordance with the present disclosure;

FIGS. 7A and 7B are graphs of outlier identification performed by an exemplary system for determining filter status, with FIG. 7A including outliers and FIG. 7B excluding outliers;

FIGS. 8A-8C are graphs illustrating ideal (FIG. 8A), expected (FIG. 8B), and observed (FIG. 8C) pressure drop (dP) profile changes with time for an operating reverse osmosis or nanofiltration element;

FIG. 9 is a graph illustrating CIP events of a dataset;

FIG. 10 is a graph illustrating unrecovered dP vs. startup dP for a dataset;

FIG. 11 is a graph illustrating cleanability vs. initial cleanability for a dataset;

FIG. 12 is a chart of fouling type and key factors based on normalized pressure drop, normalized permeate flow, and normalized salt passage;

FIGS. 13A-13F are graphs illustrating dataset analysis for pressure drop, permeate flow, and salt passage, with specific results indicative of specific fouling types, including no fouling (FIG. 13A), biofouling (FIG. 13B), organic fouling (FIG. 13C), particulate fouling (FIG. 13D), scaling (FIG. 13E), and oxidation or integrity damage (FIG. 13F);

FIG. 14 is a graph illustrating identified biofouling based on a dataset;

FIG. 15 is a graph illustrating identified organic fouling based on a dataset;

FIG. 16 is a graph illustrating identified organic fouling and biofouling over organic fouling;

FIG. 17 is a graph illustrating identified organic fouling and biofouling over organic fouling;

FIG. 18 is a graph illustrating identified organic fouling, particulate fouling, biofouling, and CIP events; and

FIG. 19 is a diagrammatic view of filtration elements disposed in series with water flow passing through the filtration elements from a lead end to a tail end.

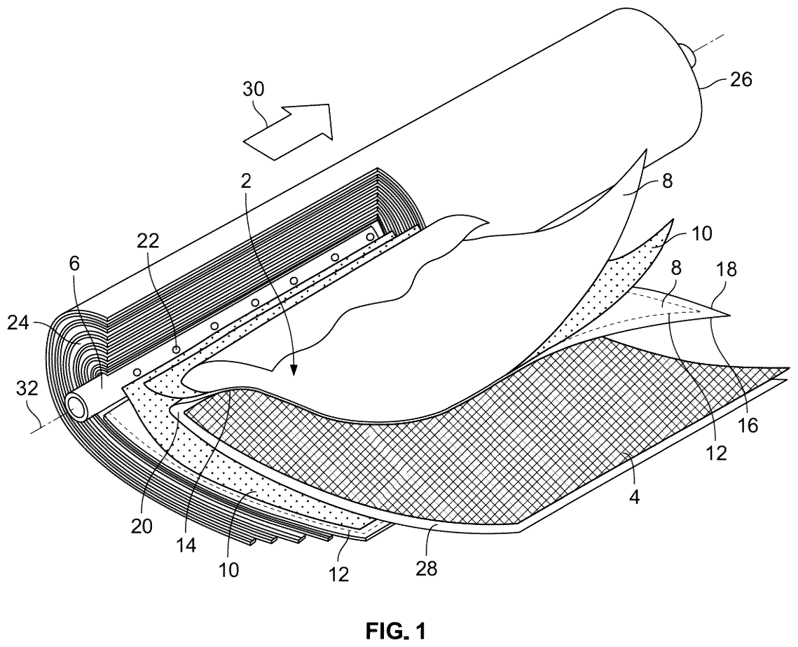

### DETAILED DESCRIPTION

The exemplary system for determining filter status discussed herein provides an accurate monitoring, analysis and identification of the fouling/scaling type occurring in filtration elements of a water treatment facility. The system can be used to determine the type of fouling/scaling occurring and can provide recommendations to the operator for when cleaning of the system should take place to ensure optimal operation. By determining the type of fouling/scaling occurring, the system can provide recommendations for the type of cleaning to be performed and chemicals to be used, resulting in accurate guidance for effective cleaning that will ensure improved operation of the water treatment facility after cleaning.

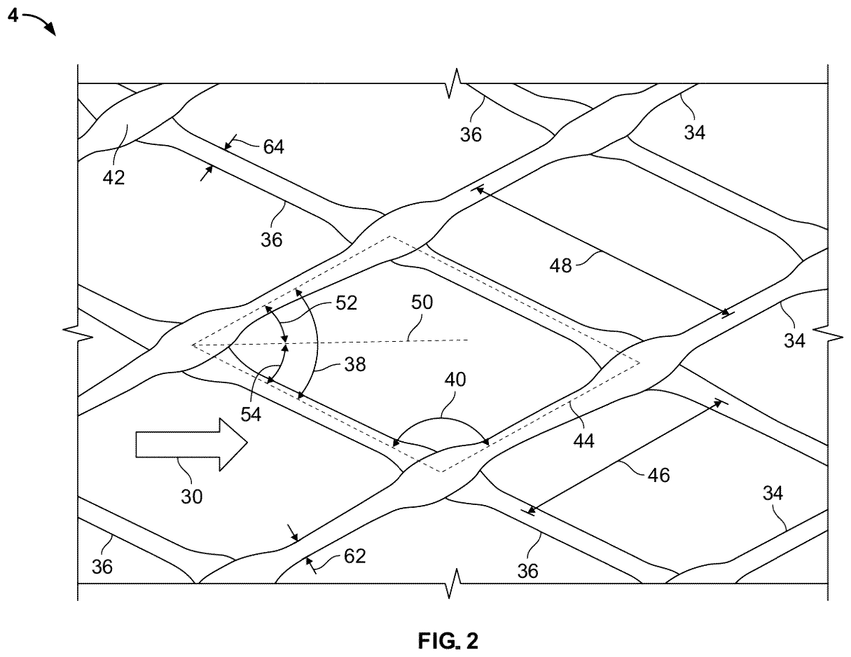

FIG. 2 is a diagrammatic view of a portion of a feed spacer sheet 4 of a filtration element showing strand thinning and several geometric relationships. The feed spacer sheet 4 is a non-woven, polymer net formed by crossing a first set of substantially parallel filaments 34 with a second set of substantially parallel filaments 36 at an angle 38, 40. The two sets of filaments 34, 36 are affixed to each other at the intersection points 42. The two crossed sets of substantially mutually parallel filaments 34, 36 form a two-dimensional array of similar parallelograms 44 (shown by dotted lines in FIG. 2), the length of their sides defining a mesh size 46, 48. Except when the two sets of filaments 34, 36 are perpendicular to each other, parallelograms have both acute 38 and obtuse 40 angles. The acute angle 38 is bisected by a line 50 drawn substantially parallel to the flow direction 30. The angle at which filaments 34, 36 cross the flow direction 30 is referred to as their traversing angle 52, 54. The strands have a spacing 46, 48, and each strand has a filament width 62, 64.

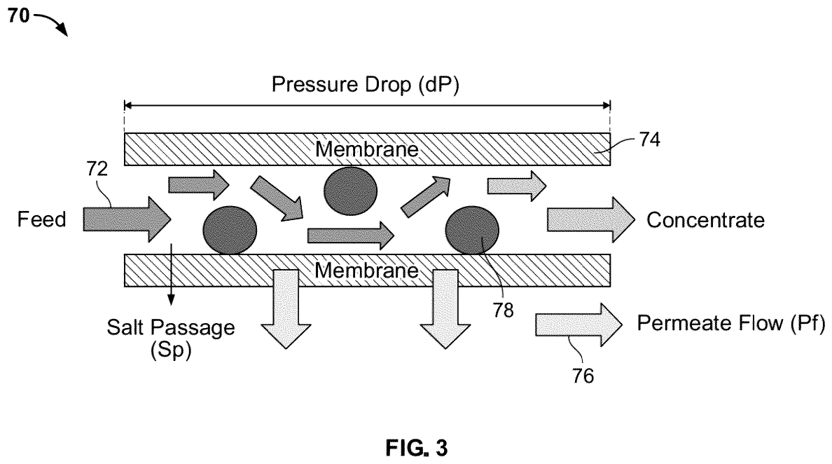

FIG. 3 is a diagrammatic view of a separation occurring in a spiral wound reverse osmosis or nanofiltration element 70. The concentrated feed solution 72 can be passed between two or more membranes 74 such that the concentrate (including waste or byproduct 78) is guided in one direction, and the dilute solution 76 (e.g., permeate flow or product) passes through the membrane 74 and out of the filtration system. The semi-permeable membrane 74 therefore allows water and a small amount of dissolved salt through. Operational goals of the water filtration system include maximizing permeate flow (Pf), minimizing salt passage (Sp), and minimizing pressure drop (dP). Feed pressure, feed temperature, and feed water quality (dissolved solids content) can affect the operation of the system.

The exemplary system can be used to identify the type of filtration module failure mode(s) (e.g., fouling, scaling, membrane failure, combinations thereof, or the like) in a nanofiltration and/or reverse osmosis system. The system can assist operators in improving the water treatment system performance through a more detailed analysis of past performance. In some embodiments, the system can be used to predict when the next cleaning should take place and recommends the most suitable cleaning procedure.

The system advantageously does not necessitate installation of an additional, external device dedicated to identifying the type of fouling. Instead, the system relies on the past performance and cleaning-in-place (CIP) events of the system to determine the type of fouling which has occurred/is occurring and the optimal cleaning for addressing the fouling. The system can be used for any water type, and does not require a special water treatment application. The system can be used to identify the periods between cleanings (e.g., between CIP events), and analyzes these periods to assess the type of fouling and cleaning recommendations. Based on this data, the system can help predict when the next cleaning should happen, and what will be the most adequate cleaning type. The system can therefore operate in a substantially automated and independent manner, allowing for a similar type of operation of the water treatment facility. As discussed herein, the system can use the first and second order slopes of the evolution of the pressure drop, permeate flow (net driving pressure), and water quality (conductivity), with this data evolution being normalized by temperature.

The exemplary system can therefore be used to identify the fouling type occurring in a filtration system and/or element without requiring any additional sensors or devices to be added to the filtration system, simplifying the overall use and reducing costs of operating the system. The system initially collects performance data associated with the filtration system, including, e.g., differential pressure, permeate flow, salt passage, or the like. The system normalizes the data to startup conditions such that normalized pressure drop, normalized permeate flow, and normalized salt passage are available and electronically stored in the system. Normalization of the data can be performed by industry procedures. (See, e.g., FilmTec™ Reverse Osmosis Membranes Technical Manual, Water Solutions, DuPont, Table 27. Design equations for projecting RO system performance: Individual element performance, Form No. 45-D01504-en, Rev. 13, p. 110 (October 2022)). Temperature can be sensed and recorded to normalize the data. The system automatically removes inconsistent data, e.g., feed flow less than concentrate flow, or the like, and removes statistical outliers.

Once the data has been normalized and inconsistencies have been removed, the system can identify membrane cleaning events (CIPs). CIP identification can be performed by generating a differencing series of dP and flow (difference between datapoints at times t and t−1), identifying the averages and standard deviations of the differencing series, looking for datapoints where the differencing value of dP or flow lie below or above a K*standard deviation threshold, and confirming if there is a gap in the data greater than a given threshold (e.g., 1 day). As used herein, the term “differencing series” implies the creation of a series, and can be generally described by taking differences between successive occurrences of the time series Δxₜ=xₜ−xₜ₋₁, such that Δxₜ have constant mean and variance and hence can be treated as a stationary series. (See, e.g., Pal, A. et al., Practical Time Series Analysis: Master Time Series Data Processing, Visualization, and Modeling Using Python, United Kingdom: Packt Publishing (2017)). This approach can also identify plant shutdowns and restarts. In some instances, the system can be used to distinguish between a CIP and a plant shutdown-restart. In some embodiments, a lack of change in dP, flow and/or salt passage before vs. after can be used by the system to indicate a plant shutdown without a CIP effect. In some embodiments, detection by the system of a change in temperature, pH and/or flowrate can be associated with a CIP mode as compared to a plant shutdown/restart.

The system can segment the data between CIPs and analyze each dataset between cleanings independently. Once inside a cleaning cycle, and once fouling type is identified, the fitted equations programmed into the system can be used to predict when the next cleaning will occur. After this next cleaning is identified, the most suitable type of cleaning is suggested. For biofouling, organic fouling and particulate fouling, a conventional caustic cleaning can be recommended. For scaling, an acid cleaning can be recommended. Specifically for biofouling, the second derivative of the slopes obtained on previous periods and the present one can be used to estimate the acceleration of biofouling (e.g., by analyzing how quickly the next CIP is needed). This can be calculated to more accurately predict when the next cleaning because of biofouling will occur, as once biofouling is present, periods between cleanings become shorter. If a combination of fouling types is detected and identified by the system, a comprehensive cleaning can be recommended, consisting of a caustic cleaning followed by an acid cleaning. The system is able to run autonomously, and advise on any fouling issue being identified, such that the system can provide guidance to the user regarding the corrective actions to be performed, and the user can decide whether the system should implement these corrective actions autonomously.

The system therefore performs data collection and analysis of past performance of the water treatment system, performs normalization of the data, cleans the data from outliers and checks for consistency of the data, identifies CIPs, performs 1^{st} and 2^{nd} order polynomial regression analysis and their coefficient of determination, applies a programmed logic to identify fouling/failure types, uses previous information to predict the next fouling type, and builds an adaptive system that includes fouling considerations. The system can include artificial intelligence and/or machine learning capabilities to improve identification of fouling types and/or predictability of fouling events. The inputs of the artificial intelligence and machine learning capabilities may be and preferably are based on feedback from operators.

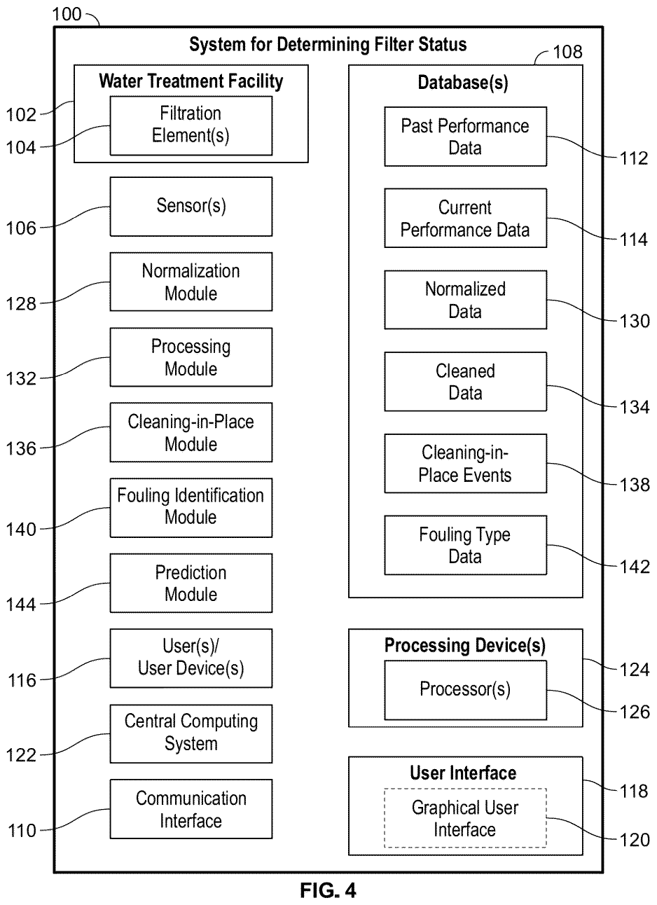

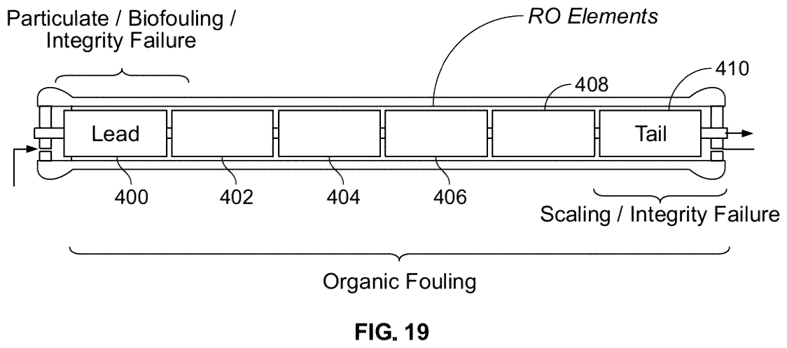

FIG. 4 is a block diagram of an exemplary system 100 for determining a filter status (hereinafter “system 100”). The system 100 generally includes one or more water treatment facilities 102 that include one or more filtration elements 104. The filtration elements 104 can be disposed back-to-back in series within a pressure vessel, e.g., filtration elements 400-410 of FIG. 19, such that water can flow into an inlet at the filtration element 400 at the lead end, flow sequentially through each of the filtration elements 400-410, and flow out of the filtration element 410 at the tail end. In general, particulate, biofouling, and/or integrity failure typically occurs in filtration elements at or near the lead end, scaling and/or integrity failure occurs in filtration elements at or near the tail end, and organic fouling can occur at any of the filtration elements. In some embodiments, a pressure vessel can receive 6 to 8 filtration elements in series. The feed water can be injected into the pressure vessel at the lead end with the filtration element at the lead end exposed to the feed water first (e.g., a first position filtration element). The filtration element furthest from the pressure vessel inlet defines the tail position filtration element. Data captured for the filtration elements within the pressure vessel can be filtration element specific and can identify and differentiate between data at the lead and tail ends of the pressure vessel to allow for accurate estimation of the fouling type.

The system 100 includes sensors 106 installed within the water treatment facility 102 to detect conditions associated with the filtration process that can be used by the system 100 to identify the fouling type. In some embodiments, the sensors 106 can be used to detect, e.g., pressure drop across each respective filtration element 104, permeate flow (the net driving pressure) through each respective filtration element 104, water quality (conductivity) with respect to each filtration element 104, and temperature of the water passing through the filtration elements 104. In some embodiments, the collected data can be for each of the filtration elements 104 (e.g., with at least one sensor 106 associated with each filtration element 104) to provide for a more detailed diagnosis of the system 100. As an example, smart sensors 106 can be incorporated into the system 100 to determine if dP increase is more predominant for lead elements (indicating particulate fouling) or tail elements (indicating scaling). In some embodiments, the collected data can be for the entire filtration system (e.g., with one or more sensors 106 installed at specific location(s) of the system 100). The sensors 106 are in electronic communication with a central computing system 122 and/or a processing device 124 of the system 100 to allow the collected data to be used for determination of a fouling type and suggested cleaning.

The system 100 includes one or more databases 108 electronically storing data associated with operation of the facility 102 and the system 100. Data can be electronically transmitted to and/or from the database 108 through a communication interface 110 of the system 100. The database 108 can include past performance data 112 (e.g., historical data) that includes information relating to, e.g., measured or detected conditions received from the sensors 106, cleaning schedules and activities, facility shutdown events, filtration element replacement(s), change of feed water source, or the like. The database 108 can include current performance data 114 that includes, e.g., measured or detected conditions received from the sensors 106 in real-time or substantially real-time, or the like.

The system 100 can include one or more users and/or user devices 116 in communication with the system 100 through the communication interface 110. The users and/or user devices 116 can be, e.g., operators for the facility 102, individuals responsible for scheduling cleaning events, or the like. The users 116 can electronically transmit or receive data to/from the system via a user interface 118 which, in some embodiments, can have a graphical user interface (GUI) 120. The GUI 120 can be a display incorporated into the user device 116 to allow for users 116 to communicate with each other and/or the system 100 via the communication interface 110.

The system 100 can include a central computing system 122 that is in communication with each of the users 116 (e.g., via their user devices) and the one or more databases 108 associated with the system 100 through the communication interface 110. The communication interface 110 is configured to provide for a communication network between components of the system 100, thereby allowing data to be electronically transmitted and/or received by the components of the system 100. The system 100 can include at least one processing device 124 with a processor 126 for receiving and processing the data stored in the system 100.

In operation, the system 100 can initially receive as input at a normalization module 128 the past performance data 112, and the normalization module 128 can be executed by the system 100 to output normalized data 130 based on temperature. Next, the system executes a processing module 132 to detect and remove outliers of the normalized data 130, and outputs cleaned data 134 for further processing. The cleaning-in-place (CIP) module 136 can be executed by the system 100 to analyze the cleaned data 134 to identify and mark cleaning-in-place events 138. This can be achieved by generating a differencing series of dP and permeate flow (difference between datapoints at times t and t−1), identifying the averages and standard deviations of the differencing series, looking for datapoints where the differencing value of dP or flow lie below or above a K*standard deviation threshold, and confirming if there is a gap in the data greater than a given threshold (e.g., 1 day). If there is a gap in the data greater than a given threshold, the system 100 can identify this point as a CIP event 138.

The system 100 segments the data between each of the identified CIP events 138 to analyze each dataset between cleanings independently. In particular, it is understood that the baseline associated with the facility 102 and/or filtration element 104 operation can vary as the filtration elements 104 are used for extended periods of time. For example, a new filtration element 104 would have a different baseline of performance as compared to a filtration element that has been in operation for 6 months and has been cleaned multiple times. As such, the system 100 segments the data and analyzes the database between each of the cleanings independently to ensure accurate identification and prediction of fouling types.

The system 100 executes a fouling identification module 140 for each of the datasets associated with operation between the respective CIP events 138 to determine the type of fouling that occurred during each dataset operation. The system 100 fits each data segment to mathematical functions, preferably to 1st and 2nd order polynomials. The system 100 analyzes the first and second order slopes of the normalized pressure drop, normalized permeate flow, and normalize salt passage. If all slopes are close to zero, the system 100 determines that normal operation of the facility 102 should continue (e.g., either no action is taken or the system 100 issues a notification via a graphical user interface 120 indicating that no fouling types have been detected and no cleaning is needed). For example, when reviewing past performance data 112, the system 100 can determine that the facility 102 should have continued operating normally without any fouling detected and no cleaning needed. When reviewing the current performance data 114, the system 100 can determine that the facility 102 should operate normally because no fouling is occurring, and no cleaning is needed.

If pressure drop increase over time fits well to a 2nd order polynomial equation, the system 100 can conclude that biofouling was likely occurring. Biofouling alone (without other type of fouling interference) is typically characterized by an initial flat normalized pressure drop (dP), followed by a 2^{nd} order polynomial increase on pressure drop as biofouling starts to develop on the membrane. Biofouling is typically more pronounced on the lead elements. Typically, normalized permeate flow decreases over time (2^{nd} order polynomial also), as net driving pressure decreases amid the increase of dP. Salt rejection can stay stable or deteriorate (thus resulting in an increase of salt passage) as a result of concentration polarization induced by the biofilm. For example, when reviewing past performance data 112, the system 100 can determine that the biofouling was occurring during this dataset and corresponding cleaning should have been performed. When reviewing the current performance data 114, the system 100 can determine that biofouling is occurring and appropriate cleaning is needed.

In some embodiments, the mode of filtration module failure in a data segment can be identified by the system 100 as biofouling if at least one of the following conditions is met: (a) the coefficient of determination of dP to a 1^{st} order polynomial is greater than 0.4, (b) the coefficient of determination of dP to a 2^{nd} order polynomial is greater than 0.7, (c) the difference between the coefficient of determination values for 2^{nd} order and 1^{st} order polynomials is greater than 0.3, (d) the coefficient of determination of Pf to a 1^{st} order polynomial is greater than 0.4, (e) the coefficient of determination of Pf to a 2^{nd} order polynomial is greater than 0.7, (f) the difference between the coefficient of determination values for 2^{nd} order and 1^{st} order polynomials is greater than 0.3, (g) the coefficient of determination of Sp to a 1st order polynomial is greater than 0.4, (h) the coefficient of determination of Sp to a 2^{nd} order polynomial is greater than 0.7, (i) the difference between the coefficient of determination values for 2^{nd} order and 1^{st} order polynomials is greater than 0.3, (j) dP increases over time in said data segment, (k) Pf decreases over time in said data segment, and/or (l) Sp increases over time in said data segment. In some embodiments, biofouling can be identified if at least one of the dP conditions is met, with Pf and Sp providing secondary (optional) support for the identification.

If normalized permeate flow decrease overtime fits well to a 2nd order polynomial equation, the system 100 can conclude that organic fouling is likely occurring. Organic fouling alone (without other type of fouling interference) is typically characterized by a decrease of the normalized permeate flow, as organics are quickly deposited on the virgin membrane, but after some time of operation it plateaus, as the amount of organics being deposited on the membrane equals the amount of organics being wiped away as a result of the cross-flow filtration mechanism. Typically, normalized pressure drop stays flat as in a pure organic fouling mechanism, and there will be no bacteria growing and blocking the feed-concentrate membrane channel. Salt passage typically decreases, as the organics being deposited on the membrane create an “additional” thickness and resistance on the membrane, that typically improves its salt passage over time. For example, when reviewing past performance data 112, the system 100 can determine that the organic fouling was occurring during this dataset and corresponding cleaning should have been performed. When reviewing the current performance data 114, the system 100 can determine that organic fouling is occurring, and appropriate cleaning is needed.

In some embodiments, the mode of filtration module failure in a data segment can be identified by the system 100 as organic fouling if at least one of the following conditions is met: (a) the coefficient of determination of Pf to a 1^{st} order polynomial is greater than 0.4, (b) the coefficient of determination of Pf to a 2^{nd} order polynomial is greater than 0.7, (c) the difference between the coefficient of determination values for the 2^{nd} order and 1^{st} order polynomials fitted to Pf is greater than 0.3, (d) the coefficient of determination of Sp to a 1^{st} order polynomial is greater than 0.4, (e) the coefficient of determination of Sp to a 2^{nd} order polynomial is greater than 0.7, (f) the difference between the coefficient of determination values for 2^{nd} order and 1st order polynomials fitted to fitted to Sp is greater than 0.3, (g) the coefficient of determination of dP to a 1st order polynomial is greater than 0.7, (h) the coefficient of determination of dP to a 2^{nd} order polynomial is greater than 0.7, (i) the difference between the coefficient of determination values for 2^{nd} order and 1^{st} order polynomials fitted to fitted to dP is less than 0.3, (j) dP remains constant with time in said data segment, (k) Pf decreases over time in said data segment, and/or (l) Sp decreases over time. In some embodiments, organic fouling can be identified if at least one of the Pf conditions is met, with dP and Sp providing secondary (optional) support for the identification.

If normalized pressure drop increase fits better to a 1st order polynomial, the system 100 can conclude that either scaling or particulate fouling is occurring. Scaling is typically associated by a lower rate of pressure drop increase compared to particulate fouling, as it typically takes up a bit more time for the scaling precipitate to crystalize and form. On the other hand, particulate fouling is typically a faster process, for example when ultrafiltration is fouled and a trans-membrane pressure increase is observed between backwash cycles. Scaling typically occurs together or in combination with an increase of salt passage over time, as scaling precipitated on the membrane increases concentration polarization on the boundary layer of the membrane. This can go associated with a decrease of normalized permeate flow over time as osmotic pressure increases accordingly. Particulate fouling occurs when particulate matter clogs the membrane, and this can lead to a decrease in normalized permeate flow as net driving pressure decreases over time. For example, when reviewing past performance data 112, the system 100 can determine that the scaling or particulate fouling was occurring during this dataset and corresponding cleaning should have been performed. When reviewing the current performance data 114, the system 100 can determine that scaling or particulate fouling is occurring and appropriate cleaning is needed.

In some embodiments, the mode of filtration module failure in a data segment can be identified by the system 100 as scaling if at least one of the following conditions is met: (a) the coefficient of determination of dP to a 1^{st} order polynomial is greater than 0.7, (b) the coefficient of determination of dP to a 2^{nd} order polynomial is greater than 0.7, (c) the difference between the coefficient of determination values for 2^{nd} order and 1^{st} order polynomials fitted to dP is less than 0.3, (d) the coefficient of determination of Sp to a 1^{st} order polynomial is greater than 0.7, (e) the coefficient of determination of Sp to a 2^{nd} order polynomial is greater than 0.7, (f) the difference between the coefficient of determination values for 2^{nd} order and 1^{st} order polynomials fitted to Sp is less than 0.3, (g) the coefficient of determination of Pf to a 1^{st} order polynomial is greater than 0.7, (h) the coefficient of determination of Pf to a 2^{nd} order polynomial is greater than 0.7, (i) the difference between the coefficient of determination values for 2^{nd} order and 1^{st} order polynomials fitted to Pf is less than 0.3, (j) dP increases with time in said data segment, preferentially in tail elements, (k) Pf decreases with time in said data segment, and/or (l) Sp increases with time in said data segment. In some embodiments, scaling can be identified if at least one of the dP conditions is met and the dP condition distribution in the system (preferentially dP increases in tail elements), with Pf and Sp providing secondary (optional) support for the identification.

In some embodiments, the mode of filtration module failure in a data segment can be identified by the system 100 as particulate fouling if at least one of the following conditions is met: (a) the coefficient of determination of dP to a 1^{st} order polynomial is greater than 0.7, (b) the coefficient of determination of dP to a 2^{nd} order polynomial is greater than 0.7, (c) the difference between the coefficient of determination values for 2^{nd} order and 1^{st} order polynomials fitted to dP is less than 0.3, (d) the coefficient of determination of Pf to a 1^{st} order polynomial is greater than 0.7, (e) the coefficient of determination of Pf to a 2^{nd} order polynomial is greater than 0.7, (f) the difference between the coefficient of determination values for 2^{nd} order and 1st order polynomials fitted to Pf is less than 0.3, (g) the coefficient of determination of Sp to a 1^{st} order polynomial is greater than 0.7, (h) the coefficient of determination of Sp to a 2^{nd} order polynomial is greater than 0.7, (i) the difference between the coefficient of determination values for 2^{nd} order and 1^{st} order polynomials fitted to Sp is less than 0.3, (j) dP increases over time in said data segment, preferentially in lead elements, (k) Pf decreases over time in said data segment, and/or (l) Sp increases with time in said data segment, preferentially in tail elements. In some embodiments, particulate fouling can be identified if at least one of the dP conditions is met and the dP condition distribution in the system (preferentially dP increases in lead elements), with Pf and Sp providing secondary (optional) support for the identification.

If normalized permeate flow increase fits a 1st order polynomial, the system 100 can conclude that potential problems with the membrane integrity (such as chemical degradation of the membrane or halogenation, or physical integrity problems of the membrane elements) may be occurring. Membrane integrity failure typically causes an increase of salt passage over time. For example, when reviewing past performance data 112, the system 100 can determine that potential problems with the membrane integrity were occurring and appropriate action should have been taken. When reviewing the current performance data 114, the system 100 can determine that membrane integrity issues may be occurring and appropriate action should be taken.

In some embodiments, the mode of filtration module failure in a data segment can be identified by the system 100 as membrane integrity failure if at least one of the following conditions is met: (a) the coefficient of determination of Pf to a 1^{st} order polynomial is greater than 0.7, (b) the coefficient of determination of Pf to a 2^{nd} order polynomial is greater than 0.7, (c) the difference between the coefficient of determination values for the 2^{nd} order and 1^{st} order polynomials fitted to Pf is less than 0.3, (d) the coefficient of determination of Sp to a 1st order polynomial is greater than 0.7, (e) the coefficient of determination of Sp to a 2^{nd} order polynomial is greater than 0.7, (f) the difference between the coefficient of determination values for 2^{nd} order and 1^{st} order polynomials fitted to fitted to Sp is less than 0.3, (g) the coefficient of determination of dP to a 1^{st} order polynomial is greater than 0.7, (h) the coefficient of determination of dP to a 2^{nd} order polynomial is greater than 0.7, (i) the difference between the coefficient of determination values for 2^{nd} order and 1^{st} order polynomials fitted to fitted to dP is less than 0.3, (j) dP remains constant with time in said data segment, (k) Pf increases over time in said data segment, and/or (l) Sp increases over time in said data segment. In some embodiments, membrane integrity failure can be identified based on an increase in permeate flow with simultaneous increase in salt passage, with dP providing secondary (optional) support for the identification.

If the system 100 concludes that the data is indicative of a specific type of fouling event, the system 100 can output a notification via a graphical user interface 120 with the fouling event detected, supporting data, and a recommendation for a cleaning strategy to address the fouling. If multiple fouling types are detected as occurring simultaneously from the previous analysis, such as organic fouling and then biofouling within the same period or dataset, a combined cleaning strategy is needed and the system 100 can provide a recommendation on how the combined cleaning strategy should take place. The past performance data can therefore be used to identify different types of fouling and/or combination of fouling that may be occurring based on performance of the facility 102, and electronically stores the correlations of such fouling determinations as fouling type data 142.

In some embodiments, the fouling type data 142 and the past performance data 112 can be used to evaluate the current performance data 114 to detect one or more fouling types occurring at the facility 102 and provide recommendations for cleaning operations. In some embodiments, the fouling type data 142 and the past performance data 112 can be used to evaluate the current performance data 114 and predict potential fouling which may occur. For example, the system 100 can execute a prediction module 144 to receive as input the current performance data 114 and predict the operational trajectory of the facility 102 with an estimate of the type of fouling which may occur in the near future. In some embodiments, the system 100 can execute the prediction module 144 to receive as input the past performance data 112 and estimate when specific types of fouling may occur at the facility 102, e.g., a repeated pattern of a specific fouling type at the beginning of each summer or a specific month, or the like. In such instances, the system 100 can provide notifications to the user 116 regarding a potential fouling type that may occur within a specific window of time to allow the user 116 to plan in advance for a cleaning operation. The system 100 can therefore provide accurate identification of fouling type(s) and recommend fouling type specific cleaning procedures that are focused on addressing the actual issues occurring with the facility 102, ensuring that the filtration elements 104 are properly cleaned and extending the overall life of said elements 104.

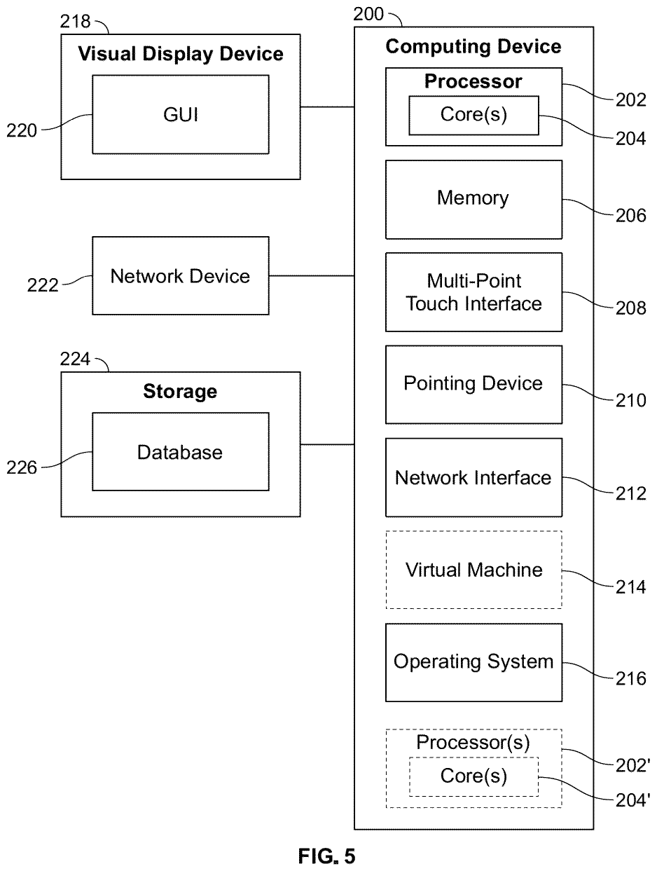

FIG. 5 is a block diagram of a computing device 200 in accordance with exemplary embodiments of the present disclosure. The computing device 200 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 206 included in the computing device 200 may store computer-readable and computer-executable instructions or software for implementing exemplary embodiments of the present disclosure (e.g., instructions for operating the normalization module, instructions for operating the cleaning module, instructions for operating the CIP module, instructions for operating the fouling identification module, instructions for operating the prediction module, instructions for operating the processing device, instructions for operating the communication interface, instructions for operating the user interface, instructions for operating the central computing system, combinations thereof, or the like). The computing device 200 also includes configurable and/or programmable processor 202 and associated core 204, and optionally, one or more additional configurable and/or programmable processor(s) 202′ and associated core(s) 204′ (for example, in the case of computer systems having multiple processors/cores), for executing computer-readable and computer-executable instructions or software stored in the memory 206 and other programs for controlling system hardware. Processor 202 and processor(s) 202′ may each be a single core processor or multiple core (204 and 204′) processor.

Virtualization may be employed in the computing device 200 so that infrastructure and resources in the computing device 200 may be shared dynamically. A virtual machine 214 may be provided to handle a process running on multiple processors so that the process appears to be using only one computing resource rather than multiple computing resources. Multiple virtual machines may also be used with one processor. Memory 206 may include a computer system memory or random access memory, such as DRAM, SRAM, EDO RAM, and the like. Memory 206 may include other types of memory as well, or combinations thereof.

A user may interact with the computing device 200 through a visual display device 218 (e.g., a personal computer, a mobile smart device, or the like), such as a computer monitor, which may display at least one user interface 220 (e.g., a graphical user interface) that may be provided in accordance with exemplary embodiments. The computing device 200 may include other I/O devices for receiving input from a user, for example, a camera, a keyboard, microphone, or any suitable multi-point touch interface 208, a pointing device 210 (e.g., a mouse). The keyboard 208 and the pointing device 210 may be coupled to the visual display device 218. The computing device 200 may include other suitable conventional I/O peripherals.

The computing device 200 may also include at least one storage device 224, such as a hard-drive, CD-ROM, eMMC (MultiMediaCard), SD (secure digital) card, flash drive, non-volatile storage media, or other computer readable media, for storing data and computer-readable instructions and/or software that implement exemplary embodiments of the system described herein. Exemplary storage device 224 may also store at least one database 226 for storing any suitable information required to implement exemplary embodiments. For example, exemplary storage device 224 can store at least one database 226 for storing information, such as data relating to the past performance data, current performance data, normalized data, cleaned data, CIP events, fouling type data, combinations thereof, or the like, and computer-readable instructions and/or software that implement exemplary embodiments described herein. The databases 226 may be updated manually or automatically at any suitable time to add, delete, and/or update one or more items in the databases.

The computing device 200 can include a network interface 212 configured to interface via at least one network device 222 with one or more networks, for example, a Local Area Network (LAN), a Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 212 may include a built-in network adapter, a network interface card, a PCMCIA network card, Pa CI/PCIe network adapter, an SD adapter, a Bluetooth adapter, a card bus network adapter, a wireless network adapter, a USB network adapter, a modem or any other device suitable for interfacing the computing device 200 to any type of network capable of communication and performing the operations described herein. Moreover, the computing device 200 may be any computer system, such as a workstation, desktop computer, server, laptop, handheld computer, tablet computer (e.g., the tablet computer), mobile computing or communication device (e.g., the smart phone communication device), an embedded computing platform, or other form of computing or telecommunications device that is capable of communication and that has sufficient processor power and memory capacity to perform the operations described herein.

The computing device 200 may run any operating system 216, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 216 may be run in native mode or emulated mode. In an exemplary embodiment, the operating system 216 may be run on one or more cloud machine instances.

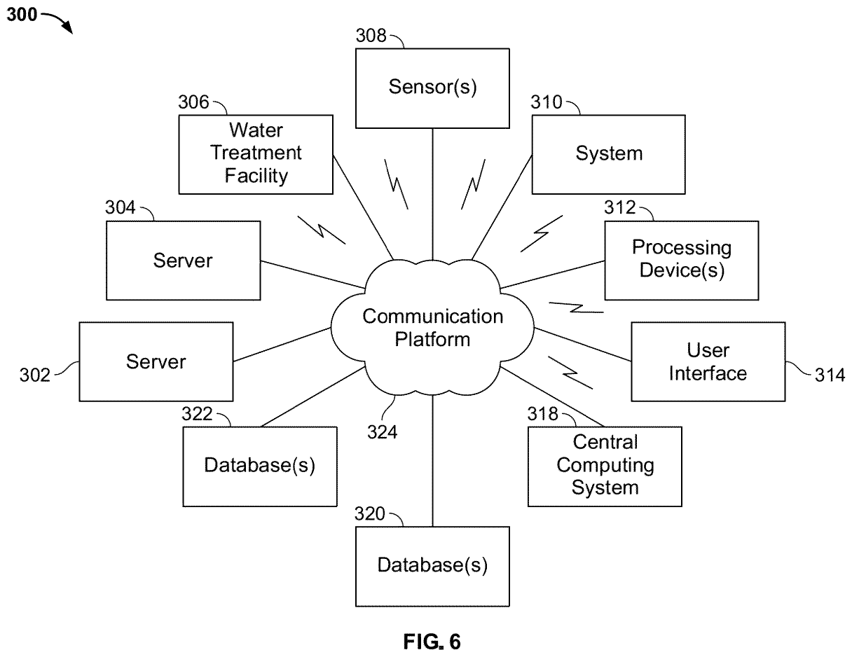

FIG. 6 is a block diagram of an exemplary system environment 300 for determining a filter status in accordance with exemplary embodiments of the present disclosure. The environment 300 can include servers 302, 304 configured to be in communication with at least one water treatment facility 306, at least one sensor 308, at least one system 310, at least one processing device 312, at least one user interface 314, and a central computing system 318 via a communication platform 324, which can be any network over which information can be transmitted between devices communicatively coupled to the network. For example, the communication platform 324 can be the Internet, Intranet, virtual private network (VPN), wide area network (WAN), local area network (LAN), and the like. In some embodiments, the communication platform 324 can be part of a cloud environment.

The environment 300 can include repositories or databases 320, 322, which can be in communication with the servers 302, 304, as well as the water treatment facility 306, sensor 308, system 310, at least one processing device 312, at least one user interface 314, and the central computing system 318, via the communications platform 324. In exemplary embodiments, the servers 302, 304, the water treatment facility 306, sensor 308, system 310, at least one processing device 312, at least one user interface 314, and the central computing system 318 can be implemented as computing devices (e.g., computing device 200). Those skilled in the art will recognize that the databases 320, 322 can be incorporated into at least one of the servers 302, 304. In some embodiments, the databases 320, 322 can store data relating to past performance data, current performance data, normalized data, cleaned data, CIP events, fouling type data, combinations thereof, or the like, and such data can be distributed over multiple databases 320, 322.

As discussed above, the exemplary system collects past performance data, normalizes the data, cleans the data to remove outliers and for consistency of the data, identifies CIPs, performs 1^{st} order and 2^{nd} order polynomial regression and a coefficient of determination, applies logic to identify fouling/failure types, and uses previous information to predict the next fouling type, with an (optionally) adaptive system that includes fouling considerations. In some embodiments, smoothing of the data can be performed after the data cleaning step. In some embodiments, three different methods can be used for outlier removal, e.g., removal of data points with sudden change, manually and Kernel smoothing, combinations thereof, or the like. In some embodiments, the system can perform a cleanability calculation to determine when a cleaning procedure should take place based on current performance data the curve/direction of the data.

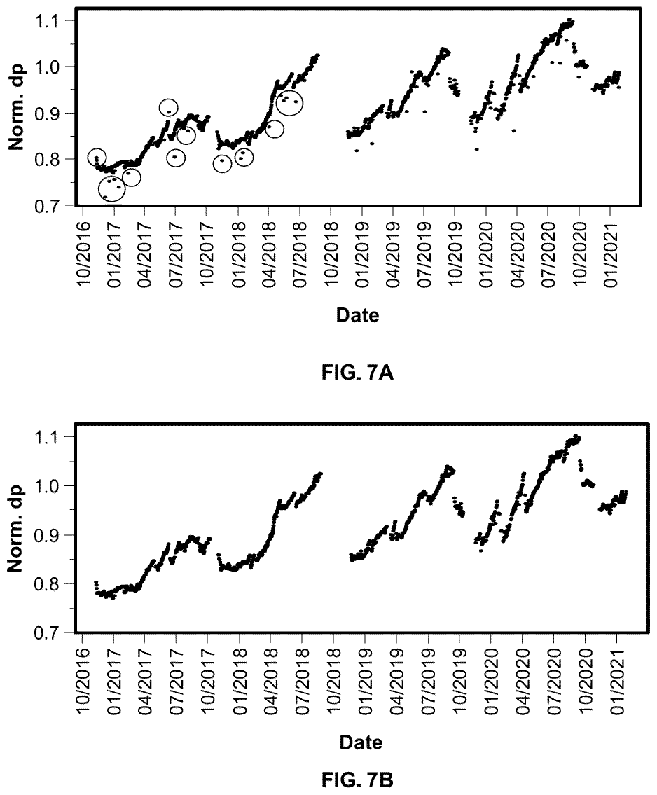

With respect to the cleaning or outlier removal step, the system can implement Wenyu's method, piecewise Kernel smoothing, or combinations thereof. The consistency check can include the following properties: feed pressure is greater than concentrate pressure, feed pressure is greater than permeate pressure, feed flow is greater than concentrate flow, feed flow is greater than permeate flow, and feed pressure is greater than a change in pressure (dP). FIGS. 7A and 7B are graphs of outlier identification performed by the system using the discussed methods, with FIG. 7A including outliers and FIG. 7B excluding outliers. For this method, data outliers general occur due to process upsets, measurement errors, or the like. Outliers can result in excessive “false positive” CIP and process stop identifications/indications. Wenyu's method is performed based on Equation 1 below.

$$Δ {\%}_{c} = \frac{{y}_{t} - {y}_{t - 1}}{{y}_{t - 1}} \times 100 \qquad ( 1 )$$

The system initially calculates the percentage change of a data point (yₜ) from a previous data point (yₜ₋₁), denoted by Δ%ₜ in Equation 1. The system then calculates the percentage change of the next data point (yₜ₊₁) from a previous data point (yₜ), denoted by Δ%ₜ₊₁. If Δ%ₜ is greater than or equal to drop limit (DL) and Δ%ₜ₊₁ is less than or equal to −DL, or Δ%ₜ is less than or equal to −DL and Δ%ₜ₊₁ is greater than or equal to DL, the point yₜ is identified an outlier. The process is repeated until all outliers have been identified and removed from the dataset. In FIG. 7A, the circled points indicate examples of some outliers that should be removed from the dataset (removed in FIG. 7B). The method is used by the system to look for sudden drop-increase or sudden increase-drop combinations. y refers to any key performance indicator (KPI). It was found that a DL of 1% was sufficient, but the DL could potentially be changed by the user. Identifying outliers is useful for detecting process anomalies and ensuring all further process data does not have “false positive” CIP or process stop indications.

In some embodiments, outlier identification can be performed by the system based on piecewise Kernel smoothing. In such embodiments, the entire data is divided into different segments, e.g., pieces. If the time gap between two pieces is greater than one (1) day, for each piece, a kernel smoother (e.g., a locally weighted scatterplot smoother or LOWESS) is developed. The Kernel smoother produces a curve formed by repeatedly finding a locally weighted fit of a simple curve at sampled points in the domain. The default setting in the system is linear (Lambda), tri-cube (Weight Function), 0.5 (Alpha), and 0 (Sampling Delta). Depending on the data, the system can automatically identify the optimal alpha value. In some embodiments, JMP™ Kernel smoothing can be used.

After the datasets have been cleaned, the system 100 can review and analyze the data to identify CIP events. The system 100 can identify when a CIP event starts and ends to segment the data around the CIP events for further processing to identify the fouling type occurring during between CIP events. In general, a CIP event is an effort to “reset” or improve the water treatment process. A CIP event also represents lost production time and chemical cost expenditures. The system 100 can rely on a number of factors as indicative of a CIP event, e.g., missing data for over one day, before and after change in KPIs (permeate flow (Pf), salt passage (Sp), and element pressure drop (dP), combinations thereof, or the like. Some potential challenges to identifying CIPs can include, e.g., outliers in the data (if not properly removed), inconsistent time interval between CIPs, the KPIs do not always change much due to a CIP, a process stop was used as a “low cost” CIP, combinations thereof, or the like. In general, the process discussed with respect to FIGS. 7A and 7B identifies and removes outliers in the data. If KPIs do not change significantly, such data can be indicative of a process stop (not a CIP), which can be useful for the system to identify. If a process stop acts as a “low cost” CIP, the system can consider such “low cost” CIP as a CIP event.

The CIP identification process can be performed by creating a differencing series of a data point (yₜ) from a previous data point (yₜ₋₁) (denoted by ∇yₜ; ∇yₜ=yₜ−yₜ₋₁). The average and standard deviations are calculated for the differencing series of each KPI. For the differencing series of KPIs, the system determines whether the differencing value of dP lies below the K* standard deviation around the average, or if the differencing value of flow lie above the K* standard deviation around the average. If the answer is yes to either question, the system determines whether there was a gap of greater than 1 day in the data. If yes, the data point (yₜ) is identified as a restart value after a CIP. The method is based on Extreme Values in Differencing Series of dP and Flow (EVDS). The method checks whether the change in the data point is far outside the expected variation. dP and Pf may be the best KPIs to identify CIP points. The default value for k is 5 but can be changed by the user. The CIP identification process can be represented by Equation 2 below:

$$\begin{matrix}If ( ∇ {dP}_{t} \leq Column Mean ( ∇ dP ) - K \cdot \\ Column Standard Deviation ( ∇ dP ) ) or ( ∇ {Flow}_{t} \geq Column Mean ( ∇ Flow ) + \\ K \cdot Column Standard Deviation ( ∇ Flow ) ) and ( ∇ {Date}_{t} > 1 )\end{matrix} \qquad ( 2 )$$

then the current observation corresponds to the restart time after CIP. The corresponding time for the previous observation indicates the CIP time.

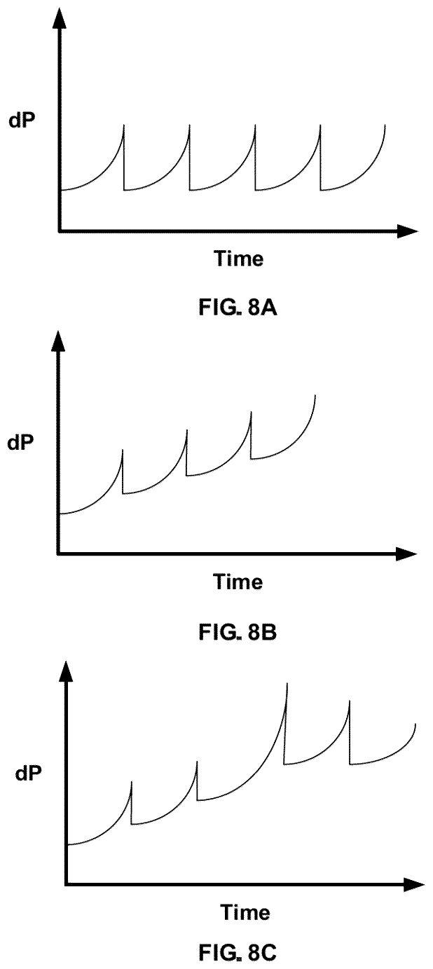

FIGS. 8A-8C are graphs illustrating ideal (FIG. 8A), expected (FIG. 8B), and observed (FIG. 8C) pressure drop (dP). The objective of a CIP is to restore the performance of the system to (ideally) its initial state. In the ideal scenario of FIG. 8A, dP returns to the initial value after cleaning. In the expected scenario of FIG. 8B, dP is reduced after every cleaning but steadily increases. In the observed scenario of FIG. 8C, dP changes inconsistently. dP is generally used to check cleaning effectiveness (other KPIs may be used in other embodiments). Indices were developed over the years to measure cleaning effectiveness, e.g., static indices compared to dP after commissioning (uncovered dP, cleanability, or the like), dynamic indices compared to dP after previous CIP (dynamic cleanability), or the like.

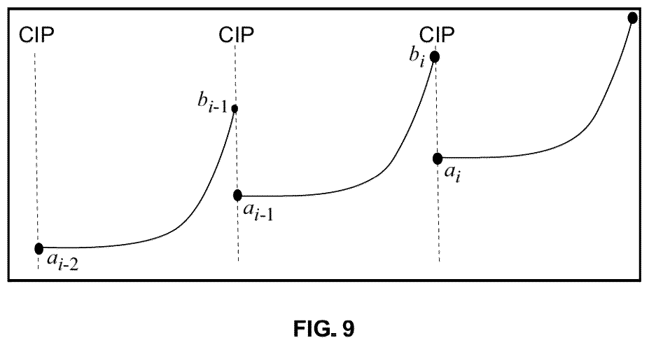

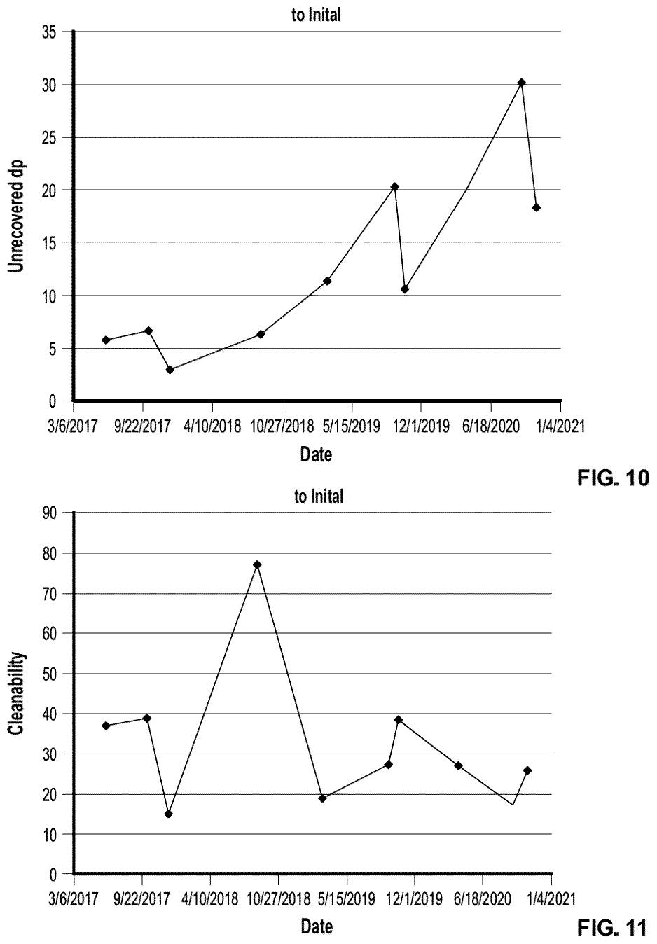

In some embodiments, the system can identify the CIP start and end points, calculate the average of three (3) dP values each at the start and end of each CIP, and calculate the relevant Cleaning Effective Index for each CIP. A similar process can be used in addition to or instead of the dP using other KPIs. Other cleaning indices can be calculated. The number of data points used for calculating the average can be changed by the user or operator of the system. For example, in some embodiments, the average can be taken over a period of at least two hours to ensure a stable reading. However, in some embodiments, an average taken over more or less than two hours can be used. FIG. 9 is a graph illustrating CIP events of a dataset, FIG. 10 is a graph illustrating unrecovered dP vs. initial for a dataset, and FIG. 11 is a graph illustrating cleanability vs. initial for a dataset. FIG. 10 illustrates the difference between the dP measured after a CIP and the initial dP (e.g., dP measured at startup before even the first CIP was performed). In a perfect system, as described in FIG. 8A, FIG. 10 would be a straight horizontal line at 0 (i.e., no unrecovered dP). The “to Initial” referenced at the top of FIG. 10 indicates the plot is for the initial dP as measured at startup before the first CIP is performed, as compared to other dP values after the first, second, third, etc. CIP events. Similarly, for FIG. 11, the cleanability captures how much of the dP increase was removed by a CIP vs. an ideal case where all the dP increase since startup is removed by a CIP. In a perfect system, as described in FIG. 8A, FIG. 11 would be a straight horizontal line at 100% (i.e., the elements are cleaned to startup conditions every time). In FIG. 9, aᵢ represents the dP value after the i^{th} CIP, and bᵢ represents the dP value before the i^{th} CIP. These values are compared to the initial value (dPᵢₙᵢₜᵢₐₗ) using Equations 3 and 4 below:

$$Unrecovered dP ( \% ) [ i ] = \frac{{a}_{i} - {dP}_{initial}}{{dP}_{initial}} \times 100 \qquad ( 3 )$$

$$Cleanability ( \% ) [ i ] = \frac{{b}_{i} - {a}_{i}}{{b}_{i} - {dP}_{initial}} \times 100 \qquad ( 4 )$$

These values can further be compared to the previous after CIP value (aᵢ₋₁) using Equations 5 and 6 below:

$$Dynamic Unrecovered dP ( \% ) [ i ] = \frac{{a}_{i} - {a}_{i - 1}}{{a}_{i - 1}} \times 100 \qquad ( 5 )$$

$$Dynamic Cleanability ( \% ) [ i ] = \frac{{b}_{i} - {a}_{i}}{{b}_{i} - {a}_{i - 1}} \qquad ( 6 )$$

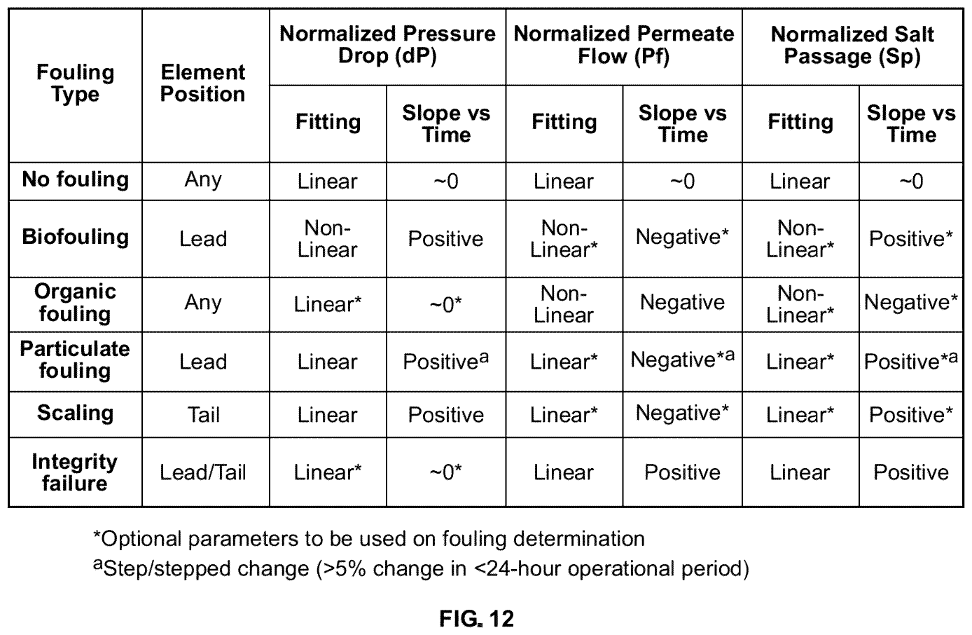

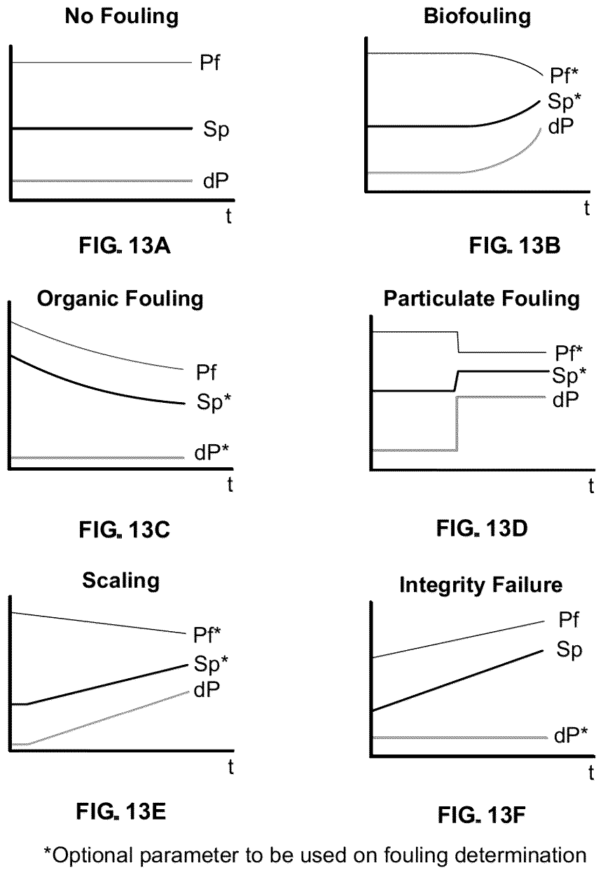

In some instances, CIP cleanings can be identified by detecting lower pressure drop, normalized flux increases or salt passage restored to the starting point. When the system starts/stops, permeate flow and salt passage oscillate until they are stabilized. Once the CIP events have been identified, the system can analyze the data in-between the CIP events to determine the type of fouling occurring based on the operational values of the system. FIG. 12 is a chart of the fouling type and the indicators/parameters based on normalized pressure drop, normalized permeate flow, and normalized salt passage. The information in FIG. 12 can be used by the system in combination with the information in FIG. 13 to identify the specific fouling type(s) occurring. For some fouling types, the indicators/parameters are reviewed based on the position of the filtration element, e.g., lead end, tail end, both lead and tail ends, or the like. Some fouling types can occur at any filtration element and, therefore, the indicators/parameters are reviewed in any position of the filtration elements. Normalized pressure drop can act as a primary indicator for no fouling, biofouling, particulate fouling, and scaling. Normalized permeate flow can act as a primary indicator for no fouling, organic fouling, particulate fouling, and element damage (e.g., integrity failure). Normalized salt passage can act as a primary indicator for scaling and element damage. These key factors can therefore be reviewed by the system for each dataset corresponding to periods in-between CIP events to determine the type of fouling occurring.

As discussed herein, the system can initially determine if there is a match based on at least one primary indicator/parameter to identify the fouling type. Such identification can be reinforced by additional primary and/or secondary indicator/parameters that match the data set. However, only a single primary indicator/parameter match is needed by the system for estimation of the fouling type. In some instances, more than one fouling type can be occurring and the system can identify such scenarios based on, e.g., two or more different primary parameters being met. In some instances, if a primary indicator/parameter match is not identified, the system can determine the fouling type based on a match of secondary parameter(s).

In some embodiments, the “decision tree” performed by the system can involve the following steps: (i) identify the slope of the primary parameter(s), (ii) identify a fitting trend of the primary parameter(s), and (iii) determine the filter element position for the identified performance change. Based on a match of at least one primary parameter with the slope vs. time (or slope vs. time and data fitting; or slope vs. time, data fitting and filter element position), the fouling type can be identified. If a match of at least one primary parameter is not found, the “decision tree” of the system can identify the slope and fitting trend of secondary parameter(s) to identify the fouling type based on the secondary parameter(s) match. If the match of the primary parameter(s) and/or secondary parameter(s) identifies more than one potential fouling type, the system can provide the potential matches to the user and the user can review the data to determine which of the potential matches is the actual fouling type occurring. In some instances, more than one type of fouling type can occur in the filter elements and the system can identify multiple fouling types based on the primary and/or secondary parameter matches. The identified fouling can be used to identify analyze current performance data (e.g., in real-time or substantially real-time) to estimate the type of fouling that may be occurring and/or may soon occur, and recommend more specific and accurate cleaning procedures to address the fouling. The identified fouling can also be used to predict when fouling may occur based on detection of repeated fouling trends occurring during specific weeks, months, and/or in view of specific water conditions (e.g., temperature, or the like).

With specific focus on FIG. 12, for no fouling, data from any filtration element position can be used, and each of dP, Pf and Sp are considered primary indicators/parameters. For no fouling to be identified, either the dP, Pf and/or Sp curve fit a linear function with a slope vs. time of about zero (e.g., a change of less than 5% over the entire operational period of time for the data set).

Still with reference to FIG. 12, for biofouling, data is reviewed with respect to the lead filtration element(s), which can include the first filtration element only (or in some embodiments can include the first and second filtration elements at the lead end of the pressure vessel). dP is the primary parameter for biofouling, with the data fitting a non-linear function and the slope vs. time being positive (both of which must occur to meet the primary parameter). Pf is one secondary parameter for biofouling, with the data fitting a non-linear function and the slope vs. time being negative (both of which must occur to meet the secondary parameter). Sp is another secondary parameter for biofouling, with the data fitting a non-linear function and the slope vs. time being positive (both of which must occur to meet the secondary parameter). Thus, in all instances discussed herein, both the function fit and the slope vs. time must be met in order to meet the primary or secondary parameter. If the primary parameter conditions are met, the system can identify the fouling type as biofouling even if the secondary parameters are not met. However, if one or more of the secondary parameters are met, the system can use this data to reinforce the original identification based on the primary parameter.

For organic fouling, data is reviewed with respect to any of the filtration elements (e.g., not limited to lead or tail end filtration elements). Pf is the primary parameter for organic fouling, with the data fitting a non-linear function and the slope vs. time being negative. dP is one secondary parameter for organic fouling, with the data fitting a linear function and the slope vs. time being about zero. Sp is another secondary parameter for organic fouling, with the data fitting a non-linear function and the slope vs. time being negative. If the primary parameter conditions are met, the system can identify the fouling type as organic fouling even if the secondary parameters are not met. However, if one or more of the secondary parameters are met, the system can use this data to reinforce the original identification based on the primary parameter.

For particulate fouling, data is reviewed with respect to the lead filtration element(s). dP is the primary parameter for particulate fouling, with the data fitting a linear function and the slope vs. time being positive. Pf is one secondary parameter for particulate fouling, with the data fitting a linear function and the slope vs. time being negative. Sp is another secondary parameter for particulate fouling, with the data fitting a linear function and the slope vs. time being positive. If the primary parameter conditions are met, the system can identify the fouling type as particulate fouling even if the secondary parameters are not met. However, if one or more of the secondary parameters are met, the system can use this data to reinforce the original identification based on the primary parameter.

For scaling, data is reviewed with respect to the tail filtration element(s), which can include the last filtration element at the tail end of the pressure vessel (or in some embodiments can include the last and next-to-last filtration elements). dP is the primary parameter for scaling, with the data fitting a linear function and the slope vs. time being positive. Pf is one secondary parameter for scaling, with the data fitting a linear function and the slope vs. time being negative. Sp is another secondary parameter for scaling, with the data fitting a linear function and the slope vs. time being positive. If the primary parameter conditions are met, the system can identify the fouling type as scaling even if the secondary parameters are not met. However, if one or more of the secondary parameters are met, the system can use this data to reinforce the original identification based on the primary parameter.

For integrity failure, data is reviewed with respect to both the lead and tail filtration element(s), which can include only the first and last filtration elements at the lead and tail ends of the pressure vessel (or in some embodiments can include two filtration elements at the lead end and two filtration elements at the tail end). Pf is one primary parameter for integrity failure, with the data fitting a linear function and the slope vs. time being positive. Sp is another primary parameter for integrity failure, with the data fitting a linear function and the slope vs. time being positive. dP is a secondary parameter for integrity failure, with the data fitting a linear function and the slope vs. time being about zero. If the primary parameter conditions are met for just one primary parameter, the system can identify the fouling type as integrity failure even if both primary parameters and/or the secondary parameter is not met. However, if both primary parameters are met and/or the secondary parameter is met, the system can use this data to reinforce the original identification based on the primary parameter.

Further, “integrity failure” may be divided into two subcategories, “chemical degradation” and “physical integrity problems.” The following Table is an Addendum to FIG. 12 in which the parameters for each of these subcategories are set forth. The notes indicated by “*” and “a” are the same as those that appear in FIG. 12. The primary and secondary parameters for the two subcategories are the same, and the data for each primary and secondary parameter fits the same order of function (linear) and the same slopes (~0 or positive) as described immediately above with respect to the parameters for the more general category, integrity failure. Any filtration element may be evaluated for chemical degradation, however, while the same elements are analyzed for physical integrity problems as described immediately above with respect to integrity failure.

TABLE
Addendum to FIG. 12

| | | Normalized | | | | | |
|---|---|---|---|---|---|---|---|
| | | pressure drop | | Normalized | | Normalized | |
| | | (dP) | | Permeate Flow (Pf) | | Salt Passage (Sp) | |
| | | | Slope | | Slope | | Slope |
| Fouling type | Element position | Fitting | vs time | Fitting | vs time | Fitting | vs time |
| Chemical | Any | Linear* | ~0* | Linear | Positive | Linear | Positive |
| degradation | | | | | | | |
| Physical integrity | Lead/Tail | Linear* | ~0* | Linear | Positive^{a} | Linear | Positive^{a} |
| problems | | | | | | | |

FIGS. 13A-13F are graphs illustrating dataset analysis for pressure drop, permeate flow, and salt passage, with specific results indicative of specific fouling types, including no fouling (FIG. 13A), biofouling (FIG. 13B), organic (FIG. 13C), particulate (FIG. 13D), scaling (FIG. 13E), and integrity (FIG. 13F). As used herein with respect to FIGS. 13A-13F, as well as throughout the disclosure, the term “rapid,” “step” or “stepped” change refers to a change of at least 5% in a given parameter in less than a 24 hour operational period; the term “steep” or “gradual” change refers to a change of at least 5% in a given parameter in a 24 hour or greater operational period, and the term “zero” or “no change” refers to a change of less than 5% over the entire operational period of time for the data set.

No fouling, as illustrated in FIG. 13A, is generally represented by no change in all factors. No cleaning would be needed with these results. Biofouling, as illustrated in FIG. 13B, is generally represented by an increase in pressure drop that fits a 2^{nd} order polynomial (with optional drop of permeate flow and increase in salt passage). A cleaning would be recommended with a specific chemical combination for biofouling. Organic fouling, as illustrated in FIG. 13C, is generally represented by a drop of permeate flow that fits a 2^{nd} order polynomial (with optional decrease in salt passage and steady pressure drop). A cleaning would be recommended with a specific chemical combination for organic fouling.

Particulate fouling, as illustrated in FIG. 13D, is generally represented by a steep increase in pressure drop (e.g., a step change) that fits a 1^{st} order polynomial (with optional steep decrease of permeate flow (e.g., a step change) that fits a 1^{st} order polynomial and steep increase salt passage (e.g., a step change)). A cleaning would be recommended with a specific chemical combination for particulate fouling. Troubleshooting of pretreatment would be recommended. Although the increase may be linear, generally such increase would be represented as a ramp. Scaling, as illustrated in FIG. 13E, is generally represented by an increase in pressure drop that fits a 1^{st} order polynomial (with optional decrease in permeate flow, and increase in salt passage that fits a 1^{st} order polynomial). A cleaning would be recommended with a specific chemical combination for scaling. Decreasing overall system recovery would be recommended. Biofouling and scaling may have similar effects, but dP increase is more predominant for lead elements for biofouling while this effect is observed in tail elements for scaling. Oxidation or integrity damage, as illustrated in FIG. 13F, is generally represented by an increase in the permeate flow that fits a 1^{st} order polynomial and an increase in salt passage that fits a 1^{st} order polynomial (with optional steady pressure drop). Replacing current filtration elements would be recommended.

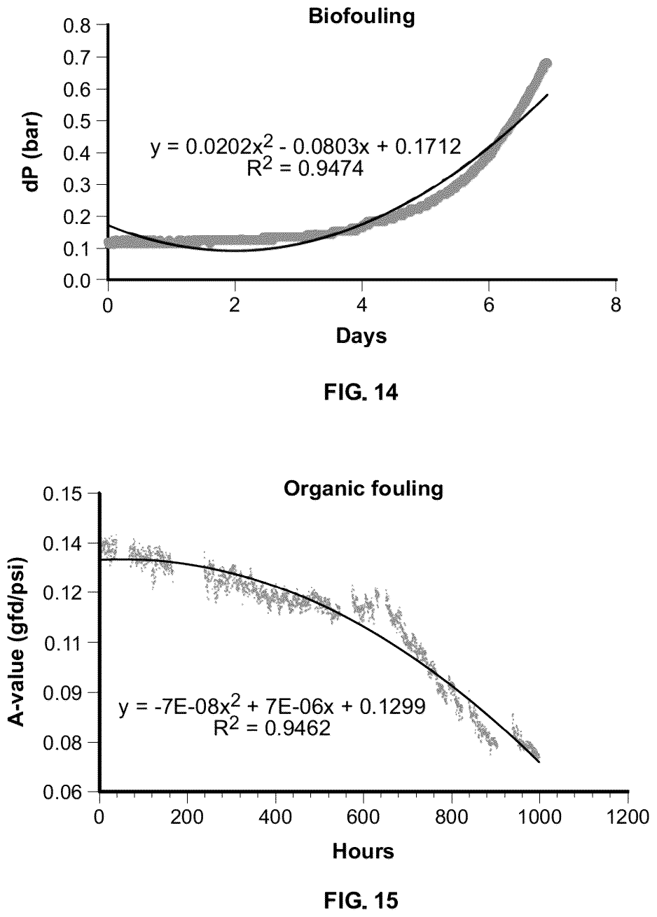

FIG. 14 is a graph illustrating identified biofouling based on a dataset, and FIG. 15 is a graph illustrating identified organic fouling based on a different dataset. These fouling identifications were performed by the system by reviewing and analyzing the data to determine the key factor conditions, and matching the key factor conditions to the guidelines discussed above. Based on these guidelines, the system developed specific functions for the dataset and identified the specific type of fouling occurring. Organic fouling differentiation was reproduced with excellent results based on experimentation of different datasets.

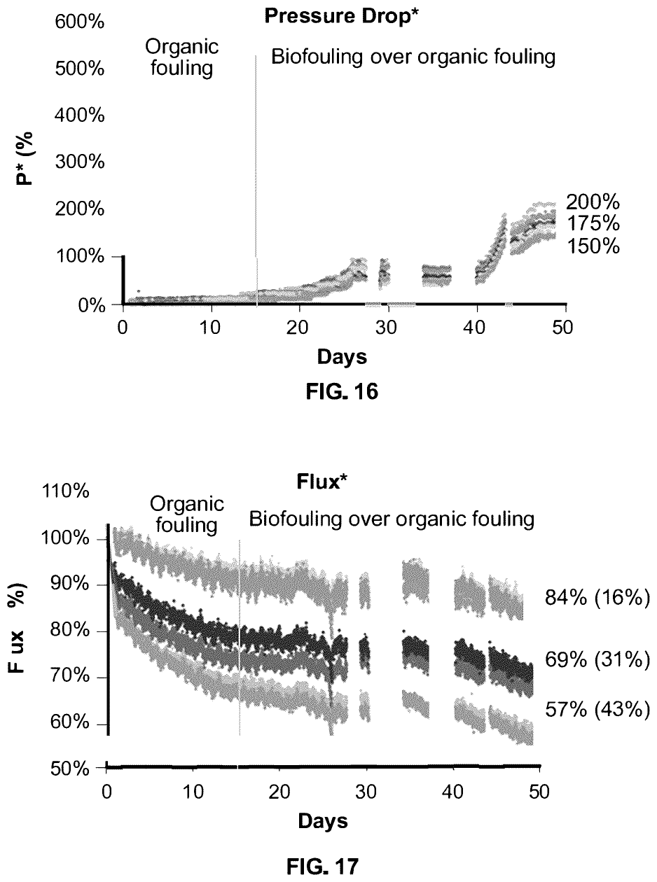

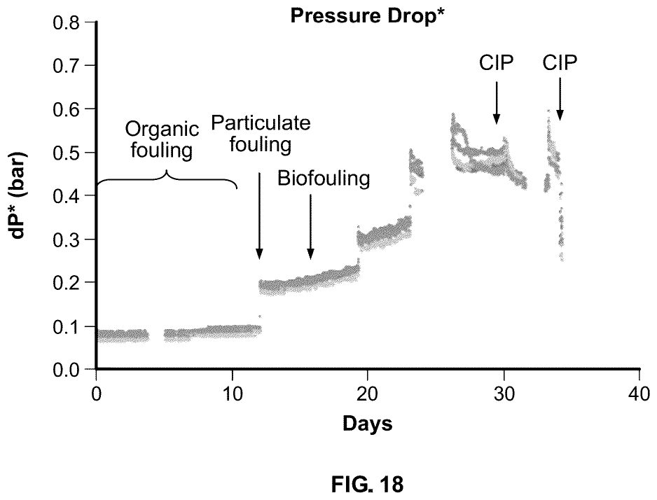

FIGS. 16 and 17 are graphs illustrating identified organic fouling and biofouling over organic fouling. Excellent reproducibility of the identifications and results as achieved using the system during experimentation. FIG. 18 is a graph illustrating identified organic fouling, particulate fouling, biofouling, and CIP events, based on a different dataset.

In some instances, the system can follow specific rules for analyzing the data and detecting the fouling type. The system can initially detect the cycles between CIP events, and for each cycle perform a 1^{st} order and 2^{nd} order polynomial regression for dP, salt passage and permeate flow. The system can be used for detection of CIP events and fouling types in both RO (single pass) and CCRO (closed circuit multiple pass) systems.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A system for determining a filter status, comprising:
a database configured to electronically store data, the data including past performance data of one or more water filtration elements; and
a processing device in communication with the database, the processing device is configured to:
receive as input the past performance data;
identify one or more data points within the past performance data indicative of a cleaning event for the one or more water filtration elements;
divide the past performance data into individual data segments, each of the individual data segments representing data of the past performance data in-between respective identified cleaning events;
fit a mathematical function to each of the individual data segments; and
identify a type of fouling occurring during each of the individual data segments based on the mathematical function fitted to the respective individual data segment.

2. The system of claim 1, wherein the processing device is further configured to normalize the past performance data to conditions at startup of the one or more water filtration elements before identifying the cleaning events.

3. The system of claim 1, wherein the processing device is further configured to account for a variation of at least one of a feedwater temperature, a feedwater composition, or a feed pressure, when normalizing the past performance data.

4. The system of claim 1, wherein the processing device is further configured to identify and remove physically inconsistent data points from the past performance data before identifying the cleaning events.

5. The system of claim 4, wherein the physically inconsistent data point is removed from the past performance data if the following conditions are not met:
feed flow is greater than concentrate flow;
the feed flow is greater than permeate flow;
feed pressure is greater than concentrate pressure; and
the feed pressure is greater than permeate pressure.

6. The system of claim 1, wherein the processing device is further configured to identify and remove statistical outlier data points from the past performance data before identifying the cleaning events.

7. The system of claim 6, wherein identifying and removing the statistical outlier data points from the past performance data comprises:
calculating a percentage change of a data point (yₜ) from a previous data point (yₜ₋₁);
calculating a percentage change of a next data point (yₜ₊₁) from the data point (yₜ);
comparing a previous percentage change with a drop limit value; and
identifying the data point (yₜ) as an outlier if the percentage changes exceed the drop limit.

8. The system of claim 1, wherein identifying the cleaning events comprises:
applying a differencing series method to a normalized pressure drop (dP) and a normalized permeate flow (Pf) from the past performance data, wherein applying the differencing series method includes:
calculating a difference between the data point (yₜ) and the previous data point (yₜ₋₁) to generate a differencing series for the normalized pressure drop (dP) and the normalized permeate flow (Pf);
calculating an average and a standard deviation for the differencing series for the normalized pressure drop (dP) and the normalized permeate flow (Pf);
comparing each value in the differencing series for the normalized pressure drop (dP) and the normalized permeate flow (Pf) to a sum of corresponding values in the differencing series and a product of a differencing constant and a corresponding standard deviation of the differencing series;
determining if a gap exists in the dataset; and
determining if the gap is wider than a CIP reference time.

9. The system of claim 1, wherein the processing device is further configured to analyze a coefficient of determination of the mathematical function and calculate derivatives of the mathematical function with respect to time, and wherein the processing device is further configured to identify the type of fouling based on the derivatives of the coefficient of determination.

10. The system of claim 1, wherein the one or more water filtration elements include at least one element selected from the group consisting of a reverse osmosis element, a nanofiltration element, and a hyperfiltration element; or wherein the system further comprises one or more sensors configured to detect and transmit data for pressure drop, salt passage, and permeate flow associated with each of the one or more water filtration elements for storage in the database as the past performance data.

11. (canceled)

12. The system of claim 1, wherein:
the past performance data includes pressure drop, salt passage, and permeate flow for each of the one or more water filtration elements; and
if no change in the pressure drop, salt passage, and permeate flow is detected, the processing device identifies a no fouling condition.

13. The system of claim 1, wherein:
the past performance data includes pressure drop, salt passage, and permeate flow for each of the one or more water filtration elements; and
if an increase in the pressure drop fits a 2^{nd} order polynomial function, the processing device identifies the type of fouling as biofouling.

14. The system of claim 1, wherein:
the past performance data includes pressure drop, salt passage, and permeate flow for each of the one or more water filtration elements; and
if a decrease of the salt passage fits a 2^{nd} order polynomial function, the processing device identifies the type of fouling as organic fouling.

15. The system of claim 1, wherein:
the past performance data includes pressure drop, salt passage, and permeate flow for each of the one or more water filtration elements; and
if a steep increase in the pressure drop of first position elements fits a 1^{st} order polynomial function, the processing device defines the type of fouling as particulate fouling.

16. The system of claim 1, wherein:
the past performance data includes pressure drop, salt passage, and permeate flow for each of the one or more water filtration elements; and
if a gradual increase in the pressure drop of tail position elements fits a 1^{st} order polynomial function, the processing device identifies the type of fouling as scaling.

17. The system of claim 1, wherein:
the past performance data includes pressure drop, salt passage, and permeate flow for each of the one or more water filtration elements; and
if an increase in the permeate flow fits a 1^{st} order polynomial function and an increase in the salt passage fits a 1^{st} order polynomial function, the processing device identifies the type of fouling as an integrity failure event.

18. The system of claim 1, wherein the processing device is further configured to:
receive as input current performance data of the one or more water filtration elements as received from one or more sensors;
analyze the current performance data based on the previous analysis of the past performance data and the identification of the type of fouling occurring during each of the individual data segments;
estimate a current type of fouling occurring at the one or more water filtration elements; and
output a recommendation for a cleaning procedure specific to the current type of fouling occurring at the one or more water filtration elements.

19. The system of claim 1, further comprising artificial intelligence, machine learning capabilities, or both artificial intelligence, machine learning capabilities, wherein the artificial intelligence or machine learning capabilities operate to improve identification of fouling types, predictability of fouling events or both identification of fouling types and predictability of fouling events.

20. A method for determining a filter status, comprising:
receiving as input to a system for determining a filter status past performance data of one or more water filtration elements, the system for determining the filter status including (i) a database configured to electronically store the past performance data, and (ii) a processing device in communication with the database;
identifying one or more data points within the past performance data indicative of a cleaning event for the one or more water filtration elements;
dividing the past performance data into individual data segments, each of the individual data segments representing data of the past performance data in-between respective identified cleaning events;
fitting a mathematical function to each of the individual data segments; and
identifying a type of fouling occurring during each of the individual data segments based on the mathematical function fitted to the respective individual data segment.

21. A non-transitory computer-readable medium storing instructions for determining a filter status that are executable by a processing device, wherein execution of the instructions by the processing device causes the processing device to:
receive as input to a system for determining a filter status past performance data of one or more water filtration elements, the system for determining the filter status including (i) a database configured to electronically store the past performance data, and (ii) the processing device in communication with the database;
identify one or more data points within the past performance data indicative of a cleaning event for the one or more water filtration elements;
divide the past performance data into individual data segments, each of the individual data segments representing data of the past performance data in-between respective identified cleaning events;
fit a mathematical function to each of the individual data segments; and
identify a type of fouling occurring during each of the individual data segments based on the mathematical function fitted to the respective individual data segment.
